(19) United States
(12) Patent Application Publication
(10) Pub. No.: US 2011/0250533 A1
(43) Pub. Date: Oct. 13, 2011

(54) TONER FOR ELECTROSTATIC IMAGE DEVELOPER, PROCESS CARTRIDGE AND IMAGE FORMING APPARATUS

(76) Inventors: Takuya Kadota, Hyogo (JP); Yoshihiro Mikuriya, Hyogo (JP); Tsuyoshi Nozaki, Osaka (JP); Atsushi Yamamoto, Shizuoka (JP); Yoshimichi Ishikawa, Hyogo (JP); Kazuoki Fuwa, Hyogo (JP); Tomohiro Fukao, Osaka (JP); Tomoharu Miki, Osaka (JP)

(21) Appl. No.: 13/084,120

(22) Filed: Apr. 11, 2011

(30) Foreign Application Priority Data
Apr. 13, 2010 (JP) 2010-092232

(51) Int. Cl. G03G 9/00; G03G 21/18; G03G 15/08

(52) U.S. Cl. 430/105; 399/111; 430/110.2; 430/109.4; 399/252

(57) ABSTRACT

To provide a toner for an electrostatic image developer, including: a core particle obtained by dispersing, in an aqueous medium, an oil phase prepared by dissolving or dispersing at least a binder resin, a colorant and a release agent in an organic solvent; and a shell layer formed of vinyl resin fine particles present on a surface of the core particle, wherein the shell layer has protruding portions formed of the vinyl resin fine particles, and wherein the vinyl resin fine particles contain 80% by mass or more of an aromatic compound which has a vinyl-polymerizable functional group, and a vinyl resin which forms the vinyl resin fine particles has a weight average molecular weight of 8,000 to 16,000.

### BACKGROUND OF THE INVENTION

1. Field of the Invention

The present invention relates to a toner for an electrostatic image developer, which includes a vinyl resin attached to the surface of the toner, usable as a latent electrostatic image developing toner in electrophotography, etc.; a process cartridge; and an image forming apparatus.

2. Description of the Related Art

In an electrophotographic image forming apparatus, colored resin particles containing a colorant are used as a toner to form a visible image.

Among a variety of toners, there are polymerization toners which have small particle diameters and narrow particle size distributions.

Also, as a toner producing method in which a polyester superior in fixability can be used as a main component of a binder resin, there is a method wherein a toner is obtained by producing an oil phase in which at least a binder resin (such as a polyester) and a colorant are dissolved or dispersed in an organic solvent, then dispersing this oil phase in a surfactant-containing aqueous phase, subsequently removing the organic solvent from the system, and washing and drying resin particles obtained (hereinafter, this method will be referred to also as “dissolution suspension method”).

There is, however, a tendency that a toner including a polyester as a main component of a binder resin, as in the dissolution suspension method, is charged with difficulty in comparison with a toner including a styrene acrylic resin as a main component. It should be particularly noted that low chargeability of toner is a greater problem in a so-called one-component developing system, wherein toner is charged by stirring and rubbing performed by a supply member (such as a supply roller) and a developer bearing member (such as a developing roller) and also charged by rubbing between the developer bearing member and a regulating member (such as a regulating blade), than in a so-called two-component developing system, wherein toner is charged by being stirred and mixed with a carrier such as iron powder, because the toner in the one-component developing system is charged on fewer occasions.

Accordingly, various examinations have been carried out, yielding methods among which there is a known method of allowing a vinyl resin superior in chargeability to be present at a toner surface.

It has, however, been found that, in the case where a shell layer is provided as a surface layer, there is an effect on toner fixability in a low-temperature range, which depends upon the molecular weight of the shell layer. Toner fixation in a low-temperature range is greatly affected by melting of the toner surface and thus, for the sake of adhesion between toner particles and adhesion between toner and paper, it is thought better to lower the temperature as much as possible at which the toner surface melts.

Moreover, in the case where resins which are highly compatible with each other are used for a core and a shell, with the resin for the shell having a lower molecular weight, the following problems may exist: the state of formation of a shell layer is affected, the shell layer forms into a film, making it impossible to reproduce a state desired in the present invention and causing a defect in the formation of the shell layer, an increase in adhesion between the shell layer and member(s) causes filming and degradation of transfer efficiency, and the spherical shape of the core and the shell causes degradation of cleanability.

For instance, the vinyl resin stated in Japanese Patent Application Laid-Open (JP-A) No. 2006-206851 causes a shell layer to form into a film, thereby hindering transferrability and cleanability. Moreover, owing to the use of many acrylic components, improvement in chargeability is not necessarily satisfactory.

Meanwhile, JP-A No. 2006-285188 states use of a vinyl copolymer resin for a shell; however, the resin's molecular weight stated in Examples hinders low-temperature fixability, and the stated amount of styrene causes a problem in terms of chargeability, so that chargeability which makes it possible to yield satisfactory image quality in any sort of environment is unobtainable.

Moreover, in the case where the vinyl resin is poured without a solvent being removed, use of a vinyl resin with few polar groups such as a carboxyl group causes a decrease in the dispersion stability of oil droplets, and thus aggregation and unification among the oil droplets occur, thereby making it impossible to obtain particles satisfactory as a toner.

JP-A No. 2008-065336 states a toner obtained by wetly producing particles which include a core containing a first latex having a glass transition temperature of 45° C. to 54° C. and a molecular weight of 33,000 to 37,000, a polyester resin as a shell surrounding the core and containing a second latex having a glass transition temperature of 55° C. to 65° C. and a molecular weight of 33,000 to 37,000, and a colorant. However, since the shell of the toner in JP-A No. 2008-065336 has a high molecular weight, the low-temperature fixability of the toner is hindered and sufficient properties thereof cannot be secured.

### BRIEF SUMMARY OF THE INVENTION

The present invention is designed in light of the above-mentioned circumstances and aimed at providing a toner which can be fixed at a low temperature, which has superior stability in terms of durability without causing smearing of developing members with a carrier, which has favorable transferrability and cleanability and which makes it possible to obtain favorable printed matter; a process cartridge; and an image forming apparatus.

As a result of carrying out a series of earnest examinations, the present inventors have found that a toner can be fixed at a low temperature, has superior stability in terms of durability without causing smearing of developing members with a carrier, has favorable transferrability and cleanability and makes it possible to obtain favorable printed matter, provided that the toner is a toner (for an electrostatic image developer) including: a core particle obtained by dispersing, in an aqueous medium, an oil phase prepared by dissolving or dispersing at least a binder resin, a colorant and a release agent in an organic solvent; and a shell layer formed of vinyl resin fine particles present on a surface of the core particle, wherein the shell layer has protruding portions formed of the vinyl resin fine particles, and wherein the vinyl resin fine particles contain 80% by mass or more of an aromatic compound which has a vinyl-polymerizable functional group, and a vinyl resin which forms the vinyl resin fine particles has a weight average molecular weight (Mw) of 8,000 to 16,000. The foregoing has led to the present invention.

The toner for an electrostatic image developer, which has a structure formed of the core particle and the shell layer (core-shell structure), can be obtained by mixing vinyl resin fine particles into a dispersion liquid in which core particles (that are produced by dispersing, in an aqueous medium, an oil phase prepared by dissolving or dispersing at least a resin, a colorant and a release agent in an organic solvent) are dispersed.

The present invention is based upon the above-mentioned findings of the present inventors, and means for solving the problems are as follows.

<1> A toner for an electrostatic image developer, including: a core particle obtained by dispersing, in an aqueous medium, an oil phase prepared by dissolving or dispersing at least a binder resin, a colorant and a release agent in an organic solvent; and a shell layer formed of vinyl resin fine particles present on a surface of the core particle, wherein the shell layer has protruding portions formed of the vinyl resin fine particles, and wherein the vinyl resin fine particles contain 80% by mass or more of an aromatic compound which has a vinyl-polymerizable functional group, and a vinyl resin which forms the vinyl resin fine particles has a weight average molecular weight of 8,000 to 16,000.
<2> The toner according to <1>, wherein the vinyl resin fine particles contain 90% by mass or more of the aromatic compound which has the vinyl-polymerizable functional group.
<3> The toner according to <1>, wherein the vinyl resin is composed of a polymerization product of the aromatic compound which has the vinyl-polymerizable functional group.
<4> The toner according to <1>, wherein the aromatic compound which has the vinyl-polymerizable functional group is styrene.
<5> The toner according to <1>, wherein the vinyl resin fine particles have a glass transition temperature of 55° C. to 100° C.
<6> The toner according to <1>, wherein the binder resin has an acid value of 2 mgKOH/g to 24 mgKOH/g.
<7> The toner according to <1>, wherein the binder resin is a polyester resin.
<8> The toner according to <1>, further including an isocyanate group-terminated modified resin dissolved in the oil phase.
<9> The toner according to <8>, wherein the modified resin has a polyester backbone in a molecular structure thereof.
<10> The toner according to <8>, further including, in the oil phase, an amine compound containing a divalent or higher amino group which is capable of reacting with the isocyanate group of the modified resin.
<11> The toner according to <1>, having an average circularity of 0.96 to 1.
<12> A nonmagnetic one-component developer including the toner according to <1>.
<13> A two-component developer including a carrier, and the toner according to <1>.
<14> A developing device including: a developer bearing member configured to bear on its surface a developer to be supplied to a latent image bearing member; a developer supplying member configured to supply the developer to a surface of the developer bearing member; a developer layer regulating member provided so as to touch the surface of the developer bearing member; and a developer container configured to accommodate the developer, wherein the developer is the nonmagnetic one-component developer according to <12>.
<15> A process cartridge detachably mountable to an image forming apparatus, including: a latent image bearing member; and a developing device configured to develop a latent image on the latent image bearing member, using a developer, the latent image bearing member and the developing device forming a single unit, wherein the developing device is the developing device according to <14>.
<16> An image forming apparatus including: a latent image bearing member configured to bear a latent image; a charging unit configured to charge a surface of the latent image bearing member uniformly; an exposing unit configured to expose the charged surface of the latent image bearing member based upon image data so as to write a latent electrostatic image on the surface of the latent image bearing member; a developing unit configured to supply a toner to the latent electrostatic image on the surface of the latent image bearing member so as to make the latent electrostatic image into a visible image; a transfer unit configured to transfer the visible image on the surface of the latent image bearing member onto a transfer target; and a fixing unit configured to fix the visible image on the transfer target, wherein the developing unit is the developing device according to <14>.
<17> An image forming method including: uniformly charging a surface of a latent image bearing member; exposing the charged surface of the latent image bearing member based upon image data so as to write a latent electrostatic image on the surface of the latent image bearing member; forming a layer of a developer with a predetermined layer thickness on a developer bearing member by means of a developer layer regulating member, and developing the latent electrostatic image on the surface of the latent image bearing member with use of the layer of the developer so as to make the latent electrostatic image into a visible image; transferring the visible image on the surface of the latent image bearing member onto a transfer target; and fixing the visible image on the transfer target, wherein the developer is the nonmagnetic one-component developer according to <12>.

Since the present invention's toner for an electrostatic image developer has protruding portions on a surface thereof, the toner is superior in transfer efficiency and cleanability.

According to <1> above, a toner superior in low-temperature fixability, transferrability and cleanability can be obtained, and a favorable image can be obtained.

According to <2> above, a toner which is even better in terms of low-temperature fixability, transferrability and cleanability can be obtained.

According to <3> above, a toner superior in low-temperature fixability, transferrability and cleanability, even if the environment changes, can be obtained.

According to <4> above, a toner which is even better in terms of low-temperature fixability, transferrability and cleanability, even if the environment changes, can be obtained.

According to <5> above, a toner superior in storage stability can be obtained.

According to <6> above, fine particles can be attached onto a core particle even more efficiently and uniformly.

According to <7> above, a toner superior in low-temperature fixability can be obtained.

According to <8> above, a toner which is unlikely to cause fixation offset can be obtained.

According to <9> above, high affinity for a resin (which has a polyester backbone in its molecular structure) in an oil phase can be yielded, and production stability can be enhanced.

According to <10> above, an isocyanate group can be surely reacted, and thus a toner which is even more unlikely to cause fixation offset can be obtained.

According to <11> above, the reproducibility of a latent electrostatic image improves, and a higher-definition image can be obtained.

By using a nonmagnetic one-component developer according to <12> above, a developing device of reduced size and with space saving capability can be obtained.

According to <13> above, a two-component developer with greater stability in terms of charging can be obtained.

According to <14> above, a developing device using a toner superior in low-temperature fixability, transferrability and cleanability can be provided.

According to <15> above, a process cartridge using a toner superior in low-temperature fixability, transferrability and cleanability can be provided.

According to <16> above, an image forming apparatus using a toner superior in low-temperature fixability, transferrability and cleanability can be provided.

According to <17> above, an image forming method using a toner superior in low-temperature fixability, transferrability and cleanability can be provided.

### BRIEF DESCRIPTION OF THE DRAWINGS

FIG. 1 is an SEM photograph exemplarily showing the external appearance of a toner particle (colored resin fine particle) with a core-shell structure, obtained in an Example of the present invention.

FIG. 2 is an SEM photograph exemplarily showing a cross section of a toner particle (colored resin fine particle) with a core-shell structure, obtained in an Example of the present invention.

FIG. 3 is an SEM photograph exemplarily showing the external appearance of a toner particle (colored resin fine particle) with a core-shell structure, obtained in a Comparative Example of the present invention.

FIG. 4 is an SEM photograph exemplarily showing a cross section of a toner particle (colored resin fine particle) with a core-shell structure, obtained in a Comparative Example of the present invention.

FIG. 5 is a schematic drawing exemplarily showing the structure of a process cartridge according to an embodiment of the present invention.

FIG. 6 is a schematic cross-sectional view exemplarily showing the structure of an image forming apparatus according to an embodiment of the present invention.

FIG. 7 is a schematic cross-sectional view exemplarily showing the structure of an image forming unit in which a photoconductor is placed.

FIG. 8 is a schematic cross-sectional view exemplarily showing the structure of a developing device.

FIG. 9 is a schematic cross-sectional view exemplarily showing the structure of a process cartridge.

### DETAILED DESCRIPTION OF THE INVENTION

### (Toner for Electrostatic Image Developer)

The present invention's toner for an electrostatic image developer includes a core particle obtained by dispersing, in an aqueous medium, an oil phase prepared by dissolving or dispersing at least a binder resin, a colorant and a release agent in an organic solvent; and a shell layer formed of vinyl resin fine particles present on a surface of the core particle.

Regarding a toner for an electrostatic image developer, including a core particle and a shell layer of vinyl resin fine particles formed on a surface of the core particle, obtained by mixing vinyl resin fine particles into a dispersion liquid in which core particles (that are produced by dispersing, in an aqueous medium, an oil phase prepared by dissolving or dispersing at least a resin, a colorant and a release agent in an organic solvent) are dispersed, the present inventors have found that the composition of the resin forming the shell layer affects the formation state of the shell layer. Specifically, by adjusting the amount of an aromatic compound having a vinyl-polymerizable functional group in the vinyl resin fine particles to 80% by mass or more, the toner can be controlled so as to have a shell structure in which protrusions are provided on the core particle.

It has been found that by adjusting the composition of the resin forming the shell layer of the toner so as to satisfy the above-mentioned range, control for formation of the shell layer partially at the toner surface becomes easy; and due to the control of the surface structure, the contact area between the toner and a photoconductor is small at the time of transfer, and the protrusions serve as points which enable cleaning to be easily carried out at the time of cleaning. Also, it has been found that by adjusting the molecular weight of the vinyl resin of the vinyl resin fine particles to the molecular weight range prescribed in the present invention, the toner's low-temperature fixability, too, can be maintained at a favorable level.

### <Core Particle>

The core particle is obtained by dispersing, in an aqueous medium, an oil phase prepared by dissolving or dispersing at least a binder resin, a colorant and a release agent in an organic solvent. The core particle may, if necessary, contain other components.

### <<Organic Solvent>>

The organic solvent is not particularly limited and may be suitably selected according to the intended purpose. It is preferred that the organic solvent be volatile and have a boiling point lower than 100° C., in view of the fact that subsequent solvent removal can be facilitated. Examples of the organic solvent include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone and methyl isobutyl ketone. These may be used individually or in combination.

In the case where the resin dissolved or dispersed in the organic solvent is a resin having a polyester backbone in its molecular structure, it is preferable to use an ester solvent such as methyl acetate, ethyl acetate or butyl acetate, or a ketone solvent such as methyl ethyl ketone or methyl isobutyl ketone, in view of the fact that the resin is highly soluble therein.

Among these solvents, methyl acetate, ethyl acetate and methyl ethyl ketone are particularly preferable in that they are highly removable.

### <<Binder Resin>>

The binder resin is not particularly limited, provided that at least part of it dissolves in the organic solvent, and the binder resin may be suitably selected according to the intended purpose. In the case where the binder resin is used for a toner for an electrostatic image developer in electrophotography, it is preferred that the binder resin be a resin having a polyester backbone in its molecular structure. The resin having a polyester backbone is not particularly limited and may be suitably selected according to the intended purpose, and examples thereof include a polyester resin, and a block polymer composed of a polyester and a resin having a backbone other than a polyester backbone in its molecular structure. Preference is given to a polyester resin in view of the fact that the uniformity of the toner improves.

The acid value of the binder resin is not particularly limited and may be suitably selected according to the intended purpose. Preference is given to the range of 2 mgKOH/g to 24 mgKOH/g.

When the acid value is less than 2 mgKOH/g, the polarity of the binder resin is low, and so it may be difficult to uniformly disperse, in oil droplets, the colorant that has polarity to some extent. When the acid value is greater than 24 mgKOH/g, transfer of the binder resin to the aqueous phase easily occurs, and thus there may be a problem easily arising, such as decrease in the dispersion stability of the oil droplets or loss of substances in a production process.

### —Polyester Resin—

The polyester resin is not particularly limited and may be suitably selected according to the intended purpose. Examples thereof include ring-opened polymers of lactones, condensation polymerization products of hydroxycarboxylic acids, and polycondensation products which are each composed of a polyol and a polycarboxylic acid, with preference being given to polycondensation products which are each composed of a polyol and a polycarboxylic acid in view of freedom of design.

The peak molecular weight of the polyester resin is not particularly limited and may be suitably selected according to the intended purpose. It is generally in the range of 1,000 to 30,000, preferably 1,500 to 10,000, more preferably 2,000 to 8,000.

When the peak molecular weight of the polyester resin is less than 1,000, there may be a decrease in heat-resistant storage stability. When the peak molecular weight of the polyester resin is greater than 30,000, the low-temperature fixability of the toner for an electrostatic image developer may degrade.

The glass transition temperature of the polyester resin is not particularly limited and may be suitably selected according to the intended purpose. It is preferably in the range of 35° C. to 80° C., more preferably 40° C. to 70° C.

When the glass transition temperature of the polyester resin is lower than 35° C., particles of the obtained toner may deform or stick to one another when placed in a high-temperature environment such as high summer, and thus the particles may not be able to behave in the manner originally intended for particles. When the glass transition temperature of the polyester resin is higher than 80° C., the fixability of the toner may degrade.

The ratio of the polyol to the polycarboxylic acid is not particularly limited and may be suitably selected according to the intended purpose; the equivalence ratio [OH]/[COOH] of the hydroxyl group [OH] to the carboxyl group [COOH] is generally in the range of 2/1 to 1/2, preferably 1.5/1 to 1/1.5, more preferably 1.3/1 to 1/1.3.

### —Polyol—

The polyol is not particularly limited and may be suitably selected according to the intended purpose. For example, the polyol is a diol, or a trihydric or higher polyol. It is preferable to use a diol solely or use a mixture composed of a diol and a small amount of a trihydric or higher polyol.

Examples of the diol include alkylene glycols (ethylene glycol, 1,2-propylene glycol, 1,3-propylene glycol, 1,4-butanediol, 1,6-hexanediol, etc.); alkylene ether glycols (diethylene glycol, triethylene glycol, dipropylene glycol, polyethylene glycol, polypropylene glycol, polytetramethylene ether glycol, etc.); alicyclic diols (1,4-cyclohexanedimethanol, hydrogenated bisphenol A, etc.); bisphenols (bisphenol A, bisphenol F, bisphenol S, etc.); alkylene oxide (ethylene oxide, propylene oxide, butylene oxide, etc.) adducts of the alicyclic diols; 4,4′-dihydroxybiphenyls such as 3,3′-difluoro-4,4′-dihydroxybiphenyl; bis(hydroxyphenyl)alkanes such as bis(3-fluoro-4-hydroxyphenyl)methane, 1-phenyl-1,1-bis(3-fluoro-4-hydroxyphenyl)ethane, 2,2-bis(3-fluoro-4-hydroxyphenyl)propane, 2,2-bis(3,5-difluoro-4-hydroxyphenyl)propane (otherwise called “tetrafluorobisphenol A”) and 2,2-bis(3-hydroxyphenyl)-1,1,1,3,3,3-hexafluoropropane; bis(4-hydroxyphenyl)ethers such as bis(3-fluoro-4-hydroxyphenyl)ether; and alkylene oxide (ethylene oxide, propylene oxide, butylene oxide, etc.) adducts of the bisphenols.

Among these, C2-C12 alkylene glycols and alkylene oxide adducts of bisphenols are preferable, and alkylene oxide adducts of bisphenols, and combinations of these and C2-C12 alkylene glycols are particularly preferable.

Examples of the trihydric or higher polyol include trihydric to octahydric or higher aliphatic alcohols (glycerin, trimethylolethane, trimethylolpropane, pentaerythritol, sorbitol, etc.); trihydric or higher phenols (trisphenol PA, phenol novolac, cresol novolac, etc.); and alkylene oxide adducts of the trihydric or higher phenols.

### —Polycarboxylic Acid—

The polycarboxylic acid is not particularly limited and may be suitably selected according to the intended purpose. For example, the polycarboxylic acid is a dicarboxylic acid, or a polycarboxylic acid (trivalent or higher carboxylic acid). It is preferable to use a dicarboxylic acid solely or use a mixture composed of a dicarboxylic acid and a small amount of a polycarboxylic acid (trivalent or higher carboxylic acid).

Examples of the dicarboxylic acid include alkylene dicarboxylic acids (succinic acid, adipic acid, sebacic acid, etc.), alkenylene dicarboxylic acids (maleic acid, fumaric acid, etc.), aromatic dicarboxylic acids (phthalic acid, isophthalic acid, terephthalic acid, naphthalenedicarboxylic acid, etc.), 3-fluoroisophthalic acid, 2-fluoroisophthalic acid, 2-fluoroterephthalic acid, 2,4,5,6-tetrafluoroisophthalic acid, 2,3,5,6-tetrafluoroterephthalic acid, 5-trifluoromethylisophthalic acid, 2,2-bis(4-carboxyphenyl)hexafluoropropane, 2,2-bis(3-carboxyphenyl)hexafluoropropane, 2,2′-bis(trifluoromethyl)-4,4′-biphenyldicarboxylic acid, 3,3′-bis(trifluoromethyl-4,4′-biphenyldicarboxylic acid, 2,2′-bis(trifluoromethyl)-3,3′-biphenyldicarboxylic acid and hexafluoroisopropylidene diphthalic anhydride.

Preferable among these are C4-C20 alkenylene dicarboxylic acids and C8-C20 aromatic dicarboxylic acids.

Examples of the polycarboxylic acid (trivalent or higher carboxylic acid) include C9-C20 aromatic polycarboxylic acids (trimellitic acid, pyromellitic acid, etc.).

Note that an acid anhydride or a lower alkyl ester (methyl ester, ethyl ester, isopropyl ester, etc.) of any of the above-mentioned compounds may be used as the polycarboxylic acid and reacted with the polyol.

### <<Colorant>>

The colorant is not particularly limited, provided that it is a known dye or a known pigment, and the colorant may be suitably selected according to the intended purpose. Examples thereof include carbon black, nigrosine dyes, iron black, Naphthol Yellow S, Hansa Yellow (10G, 5G, G), cadmium yellow, yellow iron oxide, yellow ocher, yellow lead, titanium yellow, polyazo yellow, oil yellow, Hansa Yellow (GR, A, RN, R), Pigment Yellow L, Benzidine Yellow (G, GR), Permanent Yellow (NCG), Vulcan Fast Yellow (5G, R), Tartrazine Lake, Quinoline Yellow Lake, Anthrazane Yellow BGL, isoindolinone yellow, red ocher, red lead, lead vermilion, cadmium red, cadmium mercury red, antimony vermilion, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL, F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, Bon Maroon Light, Bon Maroon Medium, Eosin Lake, Rhodamine Lake B, Rhodamine Lake Y, Alizarine Lake, Thioindigo Red B, Thioindigo Maroon, oil red, quinacridone red, pyrazolone red, polyazo red, chrome vermilion, benzidine orange, perynone orange, oil orange, cobalt blue, cerulean blue, Alkali Blue Lake, Peacock Blue Lake, Victoria Blue Lake, metal-free phthalocyanine blue, phthalocyanine blue, Fast Sky Blue, Indanthrene Blue (RS, BC), indigo, ultramarine, Prussian blue, anthraquinone blue, Fast Violet B, Methyl Violet Lake, cobalt violet, manganese violet, dioxane violet, anthraquinone violet, chrome green, zinc green, chromium oxide, viridian, emerald green, Pigment Green B, Naphthol Green B, Green Gold, Acid Green Lake, Malachite Green Lake, phthalocyanine green, anthraquinone green, titanium oxide, zinc oxide, lithopone, and mixtures of these.

The colorant is not particularly limited and may be suitably selected according to the intended purpose. For example, the colorant can be compounded with a resin to form a masterbatch.

Examples of binder resins usable for producing the masterbatch or usable to be kneaded with the masterbatch include the above-mentioned modified or unmodified polyester resins and also include polymers of styrenes such as polystyrene, poly-p-chlorostyrene and polyvinyltoluene, and of substitution products of the styrenes; styrene copolymers such as styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-α-methyl chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer and styrene-maleic acid ester copolymer; polymethyl methacrylate, polybutyl methacrylate, polyvinyl chloride, polyvinyl acetate, polyethylene, polypropylene, polyesters, epoxy resins, epoxy polyol resins, polyurethanes, polyamides, polyvinyl butyral, polyacrylic acid resins, rosins, modified rosins, terpene resins, aliphatic or alicyclic hydrocarbon resins, aromatic petroleum resins, chlorinated paraffins and paraffin waxes. These may be used individually or in combination.

The method for forming the colorant into a masterbatch is not particularly limited and may be suitably selected according to the intended purpose. For example, the masterbatch can be obtained by mixing and kneading the colorant and the resin for a masterbatch, with application of high shearing force. In doing so, an organic solvent may be used to enhance interaction between the colorant and the resin.

Also, the so-called flushing method (in which an aqueous paste containing a colorant and water is mixed and kneaded with a resin and an organic solvent, then the colorant is transferred to the resin, and the water and the organic solvent are removed) can be favorably used as well, since a wet cake of the colorant can be used without the need to change it in any way, and drying is therefore not needed. For the mixing and kneading, a high shearing dispersing apparatus such as a three roll mill can be favorably used.

### <<Release Agent>>

The release agent is not particularly limited, provided that it can be dispersed in the organic solvent for the purpose of enhancing fixability and releasability of the toner, and the release agent may be suitably selected according to the intended purpose. Examples thereof include a material (such as a wax or a silicone oil) which has sufficiently low viscosity when heated in a fixing process and which does not easily swell or become compatible with other colored resin particle materials on the surface of a fixing member.

In view of the storage stability of the toner itself, a wax is preferable because it is present as a solid in the toner when stored under normal conditions.

The wax is not particularly limited and may be suitably selected according to the intended purpose. Examples thereof include long-chain hydrocarbons and carbonyl group-containing waxes.

Examples of the long-chain hydrocarbons include polyolefin waxes (such as polyethylene wax and polypropylene wax); petroleum waxes (such as paraffin wax, Sasol Wax and microcrystalline wax); and Fischer-Tropsch wax.

Examples of the carbonyl group-containing waxes include polyalkanoic acid esters (such as carnauba wax, montan wax, trimethylolpropane tribehenate, pentaerythritol tetrabehenate, pentaerythritol diacetate dibehenate, glycerin tribehenate and 1,18-octadecanediol distearate); monoesters; diesters; polyalkanol esters (such as tristearyl trimellitate and distearyl maleate); polyalkanoic acid amides (such as ethylenediamine dibehenyl amide); polyalkylamides (such as tristearylamide trimellitate); and dialkyl ketones (such as distearyl ketone).

Among these, long-chain hydrocarbons are preferable in that they are superior in releasability. In the case where a long-chain hydrocarbon is used as the release agent, a carbonyl group-containing wax may be used in addition.

Among the carbonyl group-containing waxes, those having low molecular weights, such as monoesters and diesters, are preferable in view of low-temperature fixation.

The amount of the release agent included in the toner is not particularly limited and may be suitably selected according to the intended purpose. The amount is preferably in the range of 2% by mass to 25% by mass, more preferably 3% by mass to 20% by mass, particularly preferably 4% by mass to 15% by mass.

When the amount of the release agent included in the toner is less than 2% by mass, the fixability and releasability of the toner may not be able to be effectively improved. When the amount of the release agent included in the toner is greater than 25% by mass, the mechanical strength of the colored resin particles may decrease.

### <<Aqueous Medium>>

The aqueous medium is not particularly limited and may be suitably selected according to the intended purpose. For example, the aqueous medium may consist only of water or may consist of water and a solvent miscible with water. Examples of the solvent miscible with water include alcohols (methanol, isopropanol, ethylene glycol, etc.), dimethylformamide, tetrahydrofuran, cellosolves (methyl cellosolve, etc.) and lower ketones (acetone, methyl ethyl ketone, etc.).

Dissolved matter or dispersed matter of a toner composition may be dispersed in the aqueous medium in the presence of an inorganic dispersant or resin fine particles. Examples of the inorganic dispersant include tricalcium phosphate, calcium carbonate, titanium oxide, colloidal silica and hydroxyapatite. Use of the inorganic dispersant is preferable in that a sharp particle size distribution and stable dispersion can be secured.

### <<Other Components>>

The above-mentioned other components are not particularly limited and may be suitably selected according to the intended purpose. Examples thereof include a surfactant, a modified resin, a protective colloid and a charge controlling agent. These may be used individually or in combination.

### —Surfactant—

The surfactant may be used to produce droplets by dispersing the oil phase in the aqueous medium. The surfactant is not particularly limited and may be suitably selected according to the intended purpose. Examples thereof include anionic surfactants such as alkylbenzenesulfonates, α-olefin sulfonates and phosphoric acid esters; amine salt-based cationic surfactants such as alkylamine salts, aminoalcohol fatty acid derivatives, polyamine fatty acid derivatives and imidazoline; quaternary ammonium salt-based cationic surfactants such as alkyltrimethylammonium salts, dialkyldimethylammonium salts, alkyldimethylbenzylammonium salts, pyridinium salts, alkylisoquinolinium salts and benzethonium chloride; nonionic surfactants such as fatty acid amide derivatives and polyhydric alcohol derivatives; and amphoteric surfactants such as alanine, dodecyldi(aminoethyl)glycine, di(octylaminoethyl)glycine and N-alkyl-N,N-dimethylammonium betaines. Use of a fluoroalkyl group-containing surfactant (fluoroalkyl group-containing anionic surfactant or fluoroalkyl group-containing cationic surfactant) is preferable in that it can produce its effects even when used in very small amounts.

The fluoroalkyl group-containing anionic surfactant is not particularly limited and may be suitably selected according to the intended purpose. Examples thereof include C2-C10 fluoroalkyl carboxylic acids or metal salts thereof, disodium perfluorooctanesulfonylglutamate, sodium 3-[ω-fluoroalkyl(C6-C11)oxy]-1-alkyl(C3-C4)sulfonate, sodium 3-[ω-fluoroalkanoyl(C6-C8)-N-ethylamino]-1-propanesulfonate, fluoroalkyl(C11-C20)carboxylic acids or metal salts thereof, perfluoroalkylcarboxylic acids(C7-C13) or metal salts thereof, perfluoroalkyl(C4-C12)sulfonic acids or metal salts thereof, perfluorooctanesulfonic acid diethanolamide, N-propyl-N-(2-hydroxyethyl)perfluorooctanesulfonamide, perfluoroalkyl(C6-C10)sulfonamide propyltrimethylammonium salts, perfluoroalkyl(C6-C10)-N-ethylsulfonylglycine salts and monoperfluoroalkyl(C6-C16)ethyl phosphoric acid esters.

The fluoroalkyl group-containing cationic surfactant is not particularly limited and may be suitably selected according to the intended purpose. Examples thereof include fluoroalkyl group-containing aliphatic primary, secondary or tertiary amine acids, aliphatic quaternary ammonium salts (such as perfluoroalkyl(C6-C10)sulfonamide propyltrimethylammonium salts), benzalkonium salts, benzetonium chloride, pyridinium salts and imidazolinium salts.

### —Modified Resin—

For the purpose of, for example, increasing the mechanical strength of a toner obtained or (in the case where the toner is used as a toner for an electrostatic image developer) preventing hot offset at the time of toner fixation as well as increasing the mechanical strength, the toner may be obtained with the modified resin dissolved in the oil phase. The modified rein is not particularly limited, provided that it is an isocyanate group-terminated modified resin, and the modified rein may be suitably selected according to the intended purpose.

The backbone that the modified resin has in its molecular structure is not particularly limited and may be suitably selected according to the intended purpose. In view of uniformity of particles, it is preferred that the backbone of the modified resin be the same as that of the resin dissolved in the organic solvent, and particularly preferred that the modified resin have a polyester backbone in its molecular structure.

Isocyanate groups of the modified resin undergo hydrolysis in the process of dispersing the oil phase in the aqueous phase and thus obtaining particles, and some of the isocyanate groups change to amino groups. Then the produced amino groups react with unreacted isocyanate groups, and thus an elongation reaction proceeds. An amine compound may be used in addition, for the purpose of surely effecting the elongation reaction or introducing a cross-linking point.

The amine compound is not particularly limited and may be suitably selected according to the intended purpose. Examples thereof include diamines, polyamines (trivalent or higher amines), amino alcohols, amino mercaptans, amino acids, and compounds obtained by blocking amino groups of these.

Examples of the diamines include aromatic diamines (phenylenediamine, diethyltoluenediamine, 4,4′-diaminodiphenylmethane, tetrafluoro-p-xylylenediamine, tetrafluoro-p-phenylenediamine, etc.); alicyclic diamines (4,4′-diamino-3,3′-dimethyldicyclohexylmethane, diaminecyclohexane, isophoronediamine, etc.); and aliphatic diamines (ethylenediamine, tetramethylenediamine, hexamethylenediamine, dodecafluorohexylenediamine, tetracosafluorododecylenediamine, etc.).

Examples of the polyamines (trivalent or higher amines) include diethylenetriamine and triethylenetetramine.

Examples of the amino alcohols include ethanolamine and hydroxyethylaniline.

Examples of the amino mercaptans include aminoethyl mercaptan and aminopropyl mercaptan.

Examples of the amino acids include aminopropionic acid and aminocaproic acid.

Examples of the compounds obtained by blocking amino groups of diamines, polyamines (trivalent or higher amines), amino alcohols, amino mercaptans and amino acids include oxazoline compounds and ketimine compounds derived from ketones (acetone, methy ethyl ketone, methyl isobutyl ketone, etc.) and amines (the diamines, the polyamines (trivalent or higher amines), the amino alcohols, the amino mercaptans, the amino acids, etc.).

Preferable among these are diamines, and mixtures which are each composed of a diamine and a small amount of a polyamine (trivalent or higher amine).

The proportion of the amine compound is not particularly limited and may be suitably selected according to the intended purpose. It is preferred that the number of amino groups [NHx] in the amine compound be 4 or less times as many, more preferably 2 or less times as many, even more preferably 1.5 or less times as many, particularly preferably 1.2 or less times as many, as the number of isocyanate groups [NCO] in an isocyanate group-containing prepolymer.

When the number of amino groups [NHx] is more than 4 times as many as the number of isocyanate groups [NCO], surplus amino groups block the isocyanate groups, and the elongation reaction of the modified resin does not properly take place; consequently, the molecular weight of the polyester lowers, and the hot offset resistance of the toner may degrade.

The method for obtaining the modified resin is not particularly limited and may be suitably selected according to the intended purpose. Examples thereof include a method of obtaining an isocyanate group-containing resin by polymerization reaction with an isocyanate group-containing monomer, and a method of obtaining an active hydrogen-terminated resin by polymerization and then reacting the resin with a polyisocyanate to introduce an isocyanate group to a terminal of the polymer.

Among these, the latter method is preferable in terms of controllability yielded by introducing an isocyanate group to a terminal. Examples of the active hydrogen include hydroxyl groups (an alcoholic hydroxyl group and a phenolic hydroxyl group), amino groups, a carboxyl group and a mercapto group. Among these, an alcoholic hydroxyl group is preferable.

The method for obtaining a resin in which a polyester is terminated with the alcoholic hydroxyl group is not particularly limited and may be suitably selected according to the intended purpose. Examples thereof include a method of performing a polycondensation reaction between a polyol and a polycarboxylic acid, with the number of functional groups of the polyol being larger than that of functional groups of the polycarboxylic acid.

### —Protective Colloid—

The protective colloid may be added to stabilize dispersion droplets.

The protective colloid is not particularly limited and may be suitably selected according to the intended purpose. Examples thereof include acids such as acrylic acid, methacrylic acid, α-cyanoacrylic acid, α-cyanomethacrylic acid, itaconic acid, crotonic acid, fumaric acid, maleic acid and maleic anhydride; hydroxyl group-containing (meth)acrylic monomers such as acrylic acid β-hydroxyethyl, methacrylic acid β-hydroxyethyl, acrylic acid β-hydroxypropyl, methacrylic acid β-hydroxypropyl, acrylic acid γ-hydroxypropyl, methacrylic acid γ-hydroxypropyl, acrylic acid-3-chloro-2-hydroxypropyl, methacrylic acid-3-chloro-2-hydroxypropyl, diethyleneglycolmonoacrylic acid ester, diethyleneglycolmonomethacrylic acid ester, glycerinmonoacrylic acid ester, glycerinmonomethacrylic acid ester, N-methylolacrylamide and N-methylolmethacrylamide; vinyl alcohol and ethers of vinyl alcohol such as vinyl methyl ether, vinyl ethyl ether and vinyl propyl ether; esters of carboxyl group-containing compounds and vinyl alcohol, such as vinyl acetate, vinyl propionate and vinyl butyrate; acrylamide, methacrylamide, diacetoneacrylamide, and methylol compounds thereof; acid chlorides such as acrylic acid chloride and methacrylic acid chloride; homopolymers or copolymers of nitrogen-containing compounds such as vinyl pyridine, vinyl pyrolidone, vinyl imidazole and ethyleneimine, and of these nitrogen-containing compounds each having a heterocyclic ring; polyoxyethylene-based compounds such as polyoxyethylene, polyoxypropylene, polyoxyethylene alkylamines, polyoxypropylene alkylamines, polyoxyethylene alkylamides, polyoxypropylene alkylamides, polyoxyethylene nonyl phenyl ether, polyoxyethylene lauryl phenyl ether, polyoxyethylene stearyl phenyl ester and polyoxyethylene nonyl phenyl ester; and celluloses such as methyl cellulose, hydroxyethyl cellulose and hydroxypropyl cellulose.

In the case where a substance soluble in acid and/or alkali, such as a calcium phosphate salt, is used as a dispersion stabilizer, the substance is dissolved in an acid, e.g., hydrochloric acid, then the substance is removed from fine particles, for example by washing with water. Besides, its removal is enabled by a process such as decomposition brought about by an enzyme.

In the case where a dispersant is used, the dispersant is allowed to remain on the surfaces of toner particles; it is, however, preferable in terms of chargeability of the toner to remove the dispersant by washing after an elongation reaction and/or a cross-linking reaction.

### —Charge Controlling Agent—

The charge controlling agent may be dissolved or dispersed in the organic solvent.

The charge controlling agent is not particularly limited, and any known charge controlling agent can be used. Examples thereof include negrosine dyes, triphenylmethane dyes, chromium-containing metal complex dyes, molybdic acid chelate pigments, rhodamine dyes, alkoxy amines, quaternary ammonium salts (including fluorine-modified quaternary ammonium salts), alkylamides, phosphorus, phosphorus compounds, tungsten, tungsten compounds, fluorine-based activating agents, salicylic acid metal salts, and metal salts of salicylic acid derivatives. Specific examples thereof include BONTRON 03 as a negrosine dye, BONTRON P-51 as a quaternary ammonium salt, BONTRON S-34 as a metal-containing azo dye, E-82 as an oxynaphthoic acid metal complex, E-84 as a salicylic acid metal complex, and E-89 as a phenolic condensate (manufactured by Orient Chemical Industries); TP-302 and TP-415 as quaternary ammonium salt molybdenum complexes (manufactured by Hodogaya Chemical Industries); COPY CHARGE PSY VP2038 as a quaternary ammonium salt, COPY BLUE PR as a triphenylmethane derivative, and COPY CHARGE NEG VP2036 and COPY CHARGE NX VP434 as quaternary ammonium salts (manufactured by Hoechst AG); LRA-901, and LR-147 as a boron complex (manufactured by Japan Carlit Co., Ltd.); copper phthalocyanine, perylene, quinacridone, and azo pigments; and polymeric compounds having functional groups such as sulfonic acid group, carboxyl group, etc. or quaternary ammonium salts.

The amount of the charge controlling agent included in the toner is not particularly limited, provided that the charge controlling agent can exhibit its performance and does not hinder fixability, etc. of the toner. The amount is preferably in the range of 0.5% by mass to 5% by mass, more preferably 0.8% by mass to 3% by mass.

### <Shell Layer>

The shell layer is not particularly limited, provided that it is a layer formed of vinyl resin fine particles present on the surface of the core particle, and the shell layer may be suitably selected according to the intended purpose. For example, the shell layer may be formed such that vinyl resin fine particles cover the entire surface of the core particle, or such that vinyl resin fine particles are present at intervals.

### <<Vinyl Resin Fine Particles>>

The vinyl resin fine particles are in the form of protrusions and easily melt onto the surface of the toner for an electrostatic image developer. It is preferred that the vinyl resin fine particles be able to be fixed at a low fixation temperature, that the contact area between the vinyl resin fine particles and a photoconductor be small at the time of transfer, and that the protrusions serve as points which enable cleaning to be easily carried out at the time of cleaning. The vinyl resin fine particles can be obtained by polymerizing a monomer mixture which primarily contains, as a monomer, an aromatic compound having a vinyl-polymerizable functional group.

The amount of the aromatic compound, which has a vinyl-polymerizable functional group, contained in the vinyl resin fine particles (monomer mixture) is not particularly limited, provided that it is in the range of 80% by mass to 100% by mass, and the amount may be suitably selected according to the intended purpose, with preference being given to the range of 90% by mass to 100% by mass, more preferably 95% by mass to 100% by mass. When the amount of the aromatic compound, which has a vinyl-polymerizable functional group, contained in the vinyl resin fine particles (monomer mixture) is less than 80% by mass, formation of protruding portions on the surface of the toner may be difficult.

Examples of polymerizable functional groups usable in the aromatic compound having a vinyl-polymerizable functional group include a vinyl group, an isopropenyl group, an allyl group, an acryloyl group and a methacryloyl group.

Examples of the aromatic compound (monomer) having a vinyl-polymerizable functional group include styrene, α-methylstyrene, 4-methylstyrene, 4-ethylstyrene, 4-tert-butylstyrene, 4-methoxystyrene, 4-ethoxystyrene, 4-carboxystyrene or metal salts thereof, 4-styrenesulfonic acid or metal salts thereof, 1-vinylnaphthalene, 2-vinylnaphthalene, allylbenzene, phenoxy alkylene glycol acrylates, phenoxy alkylene glycol methacrylates, phenoxy polyalkylene glycol acrylates and phenoxy polyalkylene glycol methacrylates.

Among these, it is preferred that styrene having high chargeability be primarily used because it is easily available and superior in reactivity.

The method for producing the vinyl resin fine particles is not particularly limited and may be suitably selected according to the intended purpose. Examples thereof include a method of obtaining vinyl resin fine particles in accordance with any of (a) to (f) below.

(a) A monomer mixture is reacted by a polymerization reaction such as suspension polymerization, emulsion polymerization, seed polymerization or dispersion polymerization, and a dispersion liquid of vinyl resin fine particles is thus produced.
(b) A monomer mixture is polymerized beforehand, the obtained resin is pulverized using a fine pulverizer of mechanical rotation type, jet type, etc., then the pulverized resin is classified, and resin fine particles are thus produced.
(c) A monomer mixture is polymerized beforehand, the obtained resin is dissolved in a solvent to prepare a resin solution, the resin solution is sprayed in the form of mist, and resin fine particles are thus produced.
(d) A monomer mixture is polymerized beforehand, and a solvent is added to a resin solution prepared by dissolving the obtained resin in a solvent, or a resin solution prepared by previously dissolving a resin in a solvent with heating is cooled, thereby precipitating resin fine particles, then the solvent is removed, and resin fine particles are thus produced.
(e) A monomer mixture is polymerized beforehand, the obtained resin is dissolved in a solvent to prepare a resin solution, the resin solution is dispersed into an aqueous medium in the presence of a certain dispersant, then the solvent is removed by heating, pressure reduction, etc.
(f) A monomer mixture is polymerized beforehand, the obtained resin is dissolved in a solvent to prepare a resin solution, a certain emulsifier is dissolved in the resin solution, then water is added, and phase-inversion emulsification is thus effected.

Among these, the method of obtaining vinyl resin fine particles in accordance with (a) is preferable in that the production of vinyl resin fine particles is easy and they can be obtained in the form of a dispersion liquid, which enables their application to a subsequent step to be smooth.

In the case where a polymerization reaction is performed in accordance with (a) above as a method for producing the vinyl resin fine particles, employment of any of the following is preferable: a dispersion stabilizer is added into an aqueous medium; or such a monomer (so-called reactive emulsifier) as can impart dispersion stability to resin fine particles produced by polymerization is added into a monomer to be subjected to a polymerization reaction; or these two processes are combined to impart dispersion stability to vinyl resin fine particles produced.

If neither the dispersion stabilizer nor the reactive emulsifier is used, the following may occur: the dispersed state of the particles cannot be maintained, so that the vinyl resin cannot be obtained in the form of fine particles; the dispersion stability of the obtained resin fine particles is low, so that their storage stability is poor and they aggregate while stored; or the dispersion stability of the particles decreases in the after-mentioned resin fine particle attaching step, so that aggregation or unification among core particles easily arises, and the uniformity of the particle diameter, shape, surface, etc. of the toner obtained as a final product degrades.

The dispersion stabilizer is not particularly limited and may be suitably selected according to the intended purpose. For example, the dispersion stabilizer is a surfactant or an inorganic dispersant.

The surfactant is not particularly limited and may be suitably selected according to the intended purpose. Examples thereof include anionic surfactants such as alkylbenzenesulfonates, α-olefin sulfonates and phosphoric acid esters; amine salt-based cationic surfactants such as alkylamine salts, aminoalcohol fatty acid derivatives, polyamine fatty acid derivatives and imidazoline; quaternary ammonium salt-based cationic surfactants such as alkyltrimethylammonium salts, dialkyldimethylammonium salts, alkyldimethylbenzylammonium salts, pyridinium salts, alkylisoquinolinium salts and benzethonium chloride; nonionic surfactants such as fatty acid amide derivatives and polyhydric alcohol derivatives; and amphoteric surfactants such as alanine, dodecyldi(aminoethyl)glycine, di(octylaminoethyl)glycine and N-alkyl-N,N-dimethylammonium betaines.

The inorganic dispersant is not particularly limited and may be suitably selected according to the intended purpose. Examples thereof include tricalcium phosphate, calcium carbonate, titanium oxide, colloidal silica and hydroxyapatite.

When the vinyl resin fine particles are produced, a generally-used chain transfer agent may be used for the purpose of adjusting the molecular weight.

The chain transfer agent is not particularly limited and may be suitably selected according to the intended purpose. Preference is given to an alkyl mercaptan chain transfer agent which contains a hydrocarbon group having three or more carbon atoms.

The alkyl mercaptan chain transfer agent as a hydrophobic chain transfer agent is not particularly limited and may be suitably selected according to the intended purpose. Examples thereof include butanethiol, octanethiol, decanethiol, dodecanethiol, hexadecanethiol, octadecanethiol, cyclohexyl mercaptan, thiophenol, octyl thioglycolate, 2-octyl mercaptopropionate, 3-octyl mercaptopropionate, 2-ethylhexyl mercaptopropionate ester, 2-mercaptoethyl octanoate ester, 1,8-dimercapto-3,6-dioxaoctane, decanetrithiol and dodecyl mercaptan. These may be used individually or in combination.

The amount of the chain transfer agent added is not particularly limited, provided that it allows the molecular weight of the obtained copolymer to be adjusted to a desired molecular weight, and the amount may be suitably selected according to the intended purpose. The amount is preferably in the range of 0.01 parts by mass to 30 parts by mass, more preferably 0.1 parts by mass to 25 parts by mass, relative to the total moles of monomer components.

When the amount of the chain transfer agent added is less than 0.01 parts by mass, the molecular weight of the obtained copolymer is so great that there may be a decrease in low-temperature fixability and gelation may occur in the midst of a polymerization reaction. When the amount of the chain transfer agent added is greater than 30 parts by mass, the chain transfer agent may remain in an unreacted state, and the molecular weight of the obtained copolymer is small, thereby possibly causing smearing of members.

The vinyl resin is not particularly limited and may be suitably selected according to the intended purpose. For example, a compound having a vinyl-polymerizable functional group and an acid group (hereinafter, this compound will be referred to also as “acid monomer”) may be contained in an amount of 0% by mass to 7% by mass in the monomer mixture; it is preferred that the acid monomer be contained in an amount of 0% by mass to 4% by mass therein, and it is more preferred that no acid monomer be used (0% by mass).

When the acid monomer is used in an amount greater than 7% by mass, the obtained vinyl resin fine particles themselves have high dispersion stability; therefore, even when such vinyl resin fine particles are added into a dispersion liquid in which oil droplets are dispersed in an aqueous phase, the particles are hardly attachable at normal temperature or are attachable but easily detach at normal temperature, and thus the particles easily separate in processes such as solvent removal, washing, drying and external addition treatment. When the amount of the acid monomer used is 4% by mass or less, variation in chargeability can be reduced depending upon the environment where the obtained toner is used.

Examples of the compound (acid monomer) having a vinyl-polymerizable functional group and an acid group include carboxyl group-containing vinyl monomers or salts thereof (such as (meth)acrylic acid, maleic acid, maleic anhydride, monoalkyl maleates, fumaric acid, monoalkyl fumarates, crotonic acid, itaconic acid, monoalkyl itaconates, itaconic acid glycol monoether, citraconic acid, monoalkyl citraconates and cinnamic acid), sulfonic acid group-containing vinyl monomers, vinyl sulfuric acid monoesters or salts thereof, and phosphoric acid group-containing vinyl monomers or salts thereof. Preferable among these are (meth)acrylic acid, maleic acid, maleic anhydride, monoalkyl maleates, fumaric acid and monoalkyl fumarates.

Examples of acid groups usable in the compound (acid monomer) having a vinyl-polymerizable functional group and an acid group include a carboxylic acid, a sulfonyl acid and a phosphonyl acid.

The glass transition temperature (Tg) of the vinyl resin is not particularly limited and may be suitably selected according to the intended purpose. It is preferably in the range of 55° C. to 100° C., more preferably 55° C. to 90° C., particularly preferably 60° C. to 90° C.

When the glass transition temperature (Tg) of the vinyl resin is lower than 55° C., there may be degradation of storage stability, exemplified by an occurrence of blocking caused when the toner obtained as a final product is stored at a high temperature, high humidity and high pressure. When the glass transition temperature (Tg) of the vinyl resin is higher than 100° C., there is a decrease in the adhesion of the vinyl resin to the core particle, and the vinyl resin may separate, thereby possibly causing a problem in which members such as a regulating blade are smeared.

The glass transition temperature (Tg) of the vinyl resin varies depending upon the monomers selected; here, to improve fixability of the toner, basically speaking, it is advisable to adjust the molecular weight of the vinyl resin. It should, however, be noted that if the Tg of the vinyl resin is too low when the toner has been formed, the heat-resistant storage stability of the toner is adversely affected, and thus the Tg is preferably 55° C. or higher. If the Tg of the vinyl resin is too high, there is a decrease in the adhesion of the vinyl resin to the core particle, and the vinyl resin may separate, thereby possibly causing a problem in which members such as a regulating blade are smeared.

The weight average molecular weight (Mw) of the vinyl resin is not particularly limited, provided that it is in the range of 8,000 to 16,000, and the weight average molecular weight may be suitably selected according to the intended purpose, with preference being given to the range of 8,000 to 15,500, particularly 8,500 to 15,500.

When the weight average molecular weight of the vinyl resin is less than 8,000, the mechanical strength of the vinyl resin is low and the vinyl resin is brittle, so that the toner surface easily changes depending upon the use conditions and the application of the toner obtained as a final product, and there may be smearing, e.g., attachment of the toner to surrounding members, and a resultant occurrence of a quality-related problem. When the weight average molecular weight of the vinyl resin is greater than 16,000, there may be a decrease in the fusibility of the vinyl resin, hence a decrease in the low-temperature fixability of the toner.

Also, the state in which the vinyl resin is attached to the core particle varies depending upon the weight average molecular weight of the vinyl resin. When the weight average molecular weight of the vinyl resin is less than 8,000, there is an increase in the affinity of the vinyl resin for the core particle, and the toner is in a state likened to the state of Toner 10 shown in FIG. 4, where the toner does not have protruding portions on its surface and there may be a decrease in the transferrability and cleanability of the toner. When the weight average molecular weight of the vinyl resin is greater than 16,000, the adhesion of the vinyl resin is poor and the toner is in a state likened to the state of Toner 9 shown in FIG. 3, where the toner easily detaches.

The proportion by mass of the vinyl resin fine particles in the toner is not particularly limited and may be suitably selected according to the intended purpose. The proportion by mass of the vinyl resin fine particles is preferably in the range of 1% by mass to 20% by mass.

The volume average particle diameter of the vinyl resin fine particles in the toner is not particularly limited and may be suitably selected according to the intended purpose. It is preferably in the range of 50 nm to 200 nm, more preferably 80 nm to 160 nm, particularly preferably 100 nm to 140 nm.

The average circularity of the toner for an electrostatic image developer is not particularly limited and may be suitably selected according to the intended purpose. It is preferably in the range of 0.96 to 1, more preferably 0.96 to 0.99, particularly preferably 0.97 to 0.99. When the average circularity of the toner is less than 0.96, it may be impossible to obtain minute images and there may be a decrease in image quality.

The present invention's toner for an electrostatic image developer may include a magnetic material and thus be produced as a magnetic toner. Examples of the magnetic material include iron oxides (such as magnetite, ferrite and hematite), metals (such as iron, cobalt and nickel), and alloys or mixtures composed of the metals and aluminum, cobalt, copper, lead, magnesium, tin, zinc, antimony, beryllium, bismuth, calcium, cadmium, manganese, selenium, titanium, tungsten, vanadium, etc. Among these magnetic materials, those which are in the approximate range of 0.1 μm to 2 μm in volume average particle diameter are desirable, and the amount of any of these magnetic materials included in the toner is in the range of 5 parts by mass to 150 parts by mass per 100 parts by mass of the binder resin content.

### <Step of Producing Toner for Electrostatic Image Developer>

Next, a step of producing the present invention's toner for an electrostatic image developer will be explained.

As a method for producing an oil phase in which a resin, a colorant, etc. are dissolved or dispersed in an organic solvent, there is a method of gradually adding a resin, a colorant, etc. into an organic solvent with stirring and thus dissolving or dispersing them in the organic solvent. In the case where a pigment is used as the colorant, or components (among a release agent, a charge controlling agent, etc.) which do not easily dissolve in the organic solvent are added into the organic solvent, particles of the components are preferably reduced in size prior to their addition into the organic solvent. As described above, formation of a masterbatch with the colorant is a usable method as well, and a similar method may be applied to the release agent, the charge controlling agent, etc.

As another method, there is a method of wetly dispersing a colorant, a release agent and a charge controlling agent, if necessary with the addition of an auxiliary dispersant, in an organic solvent and thus obtaining a wet master.

As yet another method, in the case where components which melt at temperatures lower than the boiling point of an organic solvent are dispersed in the organic solvent, there is a method of stirring dispersoids, if necessary with the addition of an auxiliary dispersant, in an organic solvent and carrying out heating so as to dissolve the dispersoids temporarily in the organic solvent, then carrying out cooling with stirring or shearing so as to effect crystallization of the dispersoids, and thus producing fine crystals of the dispersoids.

The colorant, the release agent and the charge controlling agent dispersed using any of the above-mentioned methods may be dispersed after dissolved or dispersed along with the resin in the organic solvent. At the time of the dispersion, a known dispersing apparatus such as a bead mill or disc mill may be used.

### —Step of Producing Core Particle—

The method of dispersing the oil phase obtained in the above-mentioned step in an aqueous medium which contains at least a surfactant and thus producing a dispersion liquid in which core particles formed of the oil phase are dispersed is not particularly limited; for example, a known apparatus may be used, such as a low-speed shear dispersing apparatus, a high-speed shear dispersing apparatus, a friction-type dispersing apparatus, a high-pressure jet dispersing apparatus or an ultrasonic dispersing apparatus. To adjust the particle diameter of the dispersion to the range of 2 μm to 20 μm, use of a high-speed shear dispersing apparatus is preferable. In the case where a high-speed shear dispersing apparatus is used, its rotational speed is generally in the range of 1,000 rpm to 30,000 rpm, preferably 5,000 rpm to 20,000 rpm, although not particularly limited. The length of time of the dispersion is not particularly limited; in the case of a batch process, it is generally in the range of 0.1 minutes to 5 minutes. When the dispersion is carried out for over 5 minutes, it is not favorable because undesirable small-diameter particles may remain or an overly dispersed state may be created, thereby possibly making the system unstable and generating aggregates or coarse particles. The temperature at the time of the dispersion is generally in the range of 0° C. to 40° C., preferably 10° C. to 30° C. When the temperature is higher than 40° C., it is not favorable because the molecular motion is so active that there is a decrease in dispersion stability and aggregates or coarse particles are easily generated. When the temperature is lower than 0° C., there is an increase in the viscosity of the dispersion, hence an increase in the quantity of shear energy required for the dispersion, and thus there is a decrease in production efficiency. The surfactant may be the same as any of the surfactants explained in relation to the above-mentioned method for producing the resin fine particles; to disperse solvent-containing oil droplets efficiently, use of a disulfonate having a high HLB value is preferable. The concentration of the surfactant in the aqueous medium is in the range of 1% by mass to 10% by mass, preferably 2% by mass to 8% by mass, even more preferably 3% by mass to 7% by mass. When the concentration is greater than 10% by mass, it is not favorable because oil droplets may be too small in size, or conversely, coarse oil droplets may be generated owing to a decrease in dispersion stability caused by formation of an inverted micelle structure. When the concentration is less than 1% by mass, it is not favorable because oil droplets cannot be stably dispersed and thus coarse oil droplets may be generated.

### —Step of Attaching Resin Fine Particles—

In the core particle dispersion liquid obtained, droplets of the core particles can be kept present in a stable manner while stirring is carried out. In this state, the vinyl resin fine particle dispersion liquid is poured and attached onto the core particles. It is advisable to pour the vinyl resin fine particle dispersion liquid, spending 30 seconds or more. When it is poured in shorter than 30 seconds, it is not favorable because aggregated particles may be generated owing to a dramatic change in the dispersion system, or the vinyl resin fine particles may not be uniformly attached. When the vinyl resin fine particle dispersion liquid is poured in an unnecessarily long period of time, for example over 60 minutes, it is not favorable in terms of production efficiency.

For concentration adjustment, the vinyl resin fine particle dispersion liquid may be diluted or concentrated before poured into the core particle dispersion liquid. The concentration of the vinyl resin fine particle dispersion liquid is preferably in the range of 5% by mass to 30% by mass, more preferably 8% by mass to 20% by mass. When the concentration is less than 5% by mass, it is not favorable because the organic solvent concentration greatly varies owing to the pouring of the dispersion liquid and thus the resin fine particles are not sufficiently attached. When the concentration is greater than 30% by mass, it is not favorable because the resin fine particles are liable to be unevenly distributed in the core particle dispersion liquid and thus the resin fine particles may not be uniformly attached.

The reasons why the methods in the present invention make it possible for the vinyl resin fine particles to be attached to the core particles with sufficient strength are presumably as follows: when the vinyl resin fine particles are attached to droplets of the core particles, the core particles can deform freely, so that the core particles have adequate surfaces which are in contact with the vinyl resin fine particles; and the organic solvent causes the vinyl resin fine particles to swell or dissolve therein, so that bonding between the vinyl resin fine particles and the resin included in the core particles is easy. Therefore, regarding the foregoing state, the organic solvent needs to be adequately present in the system. Specifically, in the core particle dispersion liquid, the amount of the organic solvent is in the range of 50% by mass to 150% by mass, preferably 70% by mass to 125% by mass, relative to the solid content (the resin and the colorant, if necessary with the addition of the release agent, the charge controlling agent, etc.). When the amount of the organic solvent is greater than 150% by mass, it is not favorable because the amount of the toner obtained in one production process is small, which leads to a decrease in production efficiency, and the large amount of the organic solvent causes a decrease in dispersion stability and thus makes stable production difficult.

The temperature at which the vinyl resin fine particles are attached to the core particle is in the range of 10° C. to 60° C., preferably 20° C. to 45° C. When the temperature is higher than 60° C., it is not favorable because the production-related environmental load increases owing to an increase in the quantity of energy required for the production, and the presence of the vinyl resin fine particles (which are low in acid value) on the surfaces of the droplets makes the dispersion unstable, which possibly leads to generation of coarse particles. When the temperature is lower than 10° C., it is not favorable because the viscosity of the dispersion is high and the resin fine particles are not sufficiently attached.

### —Solvent Removing Step—

To remove the organic solvent from the obtained colored resin dispersion, it is possible to employ a method of gradually increasing the temperature while stirring the entire system, and completely removing the organic solvent in the droplets by evaporation. Alternatively, it is possible to employ a method of spraying the obtained colored resin dispersion into a dry atmosphere with stirring, and thus completely removing the organic solvent in the droplets, or a method of reducing the pressure while stirring the colored resin dispersion, and removing the organic solvent by evaporation. The latter two methods can be used in combination with the former method.

As the dry atmosphere into which the emulsified dispersion is sprayed, what is generally used is a gas obtained by heating air, nitrogen, carbonic acid gas, combustion gas or the like, particularly a gas flow heated to a temperature higher than or equal to the boiling point of the highest-boiling-point solvent used. Treatment with a spray dryer, belt dryer, rotary kiln or the like in a short period of time makes it possible to obtain the intended quality.

### —Aging Step—

In the case where the isocyanate group-terminated modified resin is added, an aging step may be carried out to promote an elongation reaction and/or a cross-linking reaction of the isocyanate. The length of time of the aging is generally in the range of 10 minutes to 40 hours, preferably 2 hours to 24 hours. The reaction temperature is generally in the range of 0° C. to 65° C., preferably 35° C. to 50° C.

### —Washing Step—

The dispersion liquid of the toner obtained as described above contains sub-materials such as the surfactant and the dispersant, besides the toner. Accordingly, washing is carried out to remove only the toner from these components. Examples of the method of washing include, but are not limited to, a centrifugation method, a reduced-pressure filtration method and a filter press method. A cake of the toner can be obtained by any of these methods. If the washing cannot be sufficiently performed in one operation, a step of redispersing the obtained cake in an aqueous solvent so as to produce a slurry and then removing the toner from the slurry by any of the above methods may be repeated. Also, in the case where the washing is performed by a reduced-pressure filtration method or a filter press method, the sub-materials attached to the toner may be washed away by passing an aqueous solvent through the cake. The aqueous solvent used for the washing is water or a mixed solvent prepared by mixing water with an alcohol such as methanol or ethanol, with preference being given to use of water in view of cost and an environmental load imposed by discharge treatment, etc.

### —Drying Step—

The washed toner is with a large amount of the aqueous solvent; accordingly, drying is carried out to remove the aqueous solvent and thus to obtain only the toner. For the drying, a dryer may be used such as a spray dryer, vacuum freeze dryer, reduced-pressure dryer, stationary shelf-type dryer, movable shelf-type dryer, fluid-bed dryer, rotary dryer or agitation dryer. The toner is preferably dried until the water content becomes less than 1% by mass in the end. Also, the toner which has been dried is in a softly flocculated state; if this causes trouble in practical use, the toner may be pulverized using an apparatus such as a jet mill, Henschel mixer, Super mixer, coffee mill, Oster blender or food processor so as to lessen the softly flocculated state.

### (One-Component Developer or Two-Component Developer)

The present invention's toner for an electrostatic image developer, which can be suitably used for a one-component developer, may also be used for a two-component developer that includes a carrier. This carrier may be any conventional carrier, for example iron powder, ferrite, magnetite or glass beads. Also, any such carrier may be coated with a resin. The resin used in this case is generally a known resin such as polycarbon fluoride, polyvinyl chloride, polyvinylidene chloride, a phenol resin, polyvinyl acetal, an acrylic resin or a silicone resin; in terms of the lifetime of the developer, a silicone-coated carrier is superior. Also, if necessary, conductive powder, etc. may be contained in the coating resin. Metal powder, carbon black powder, titanium dioxide powder, tin oxide powder, zinc oxide powder or the like may be used as the conductive powder. Among these conductive powders, those which are 1 μm or less in average particle diameter are preferable. When the conductive powder has an average particle diameter greater than 1 μm, it is difficult to control electrical resistance. As for the mixture ratio between the toner and the carrier in the two-component developer, the amount of the toner is generally in the range of 0.5 parts by mass to 20.0 parts by mass per 100 parts by mass of the carrier.

### (Process Cartridge)

The toner of the present invention obtained by the above-mentioned production method can be suitably used in a process cartridge of the present invention. A process cartridge of the present invention is detachably mountable to an image forming apparatus and includes a latent image bearing member, and a developing device configured to develop a latent image on the latent image bearing member, using a developer which includes the toner for an electrostatic image developer; and the latent image bearing member and the developing device form a single unit.

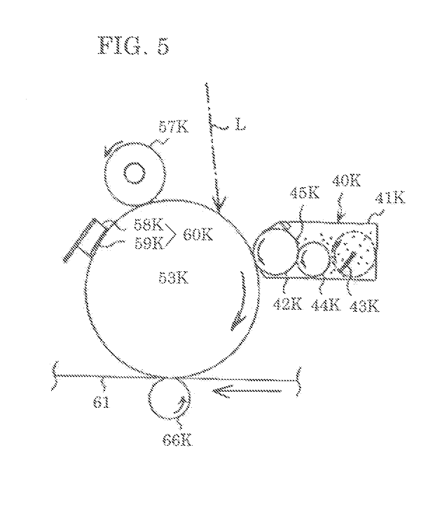

The toner of the present invention can be used in an image forming apparatus provided with a process cartridge shown, for example, in FIG. 5. The process cartridge shown in FIG. 5 includes a latent electrostatic image bearing member 53K, a latent electrostatic image bearing member charging unit 57K, a charging member 60K configured to recharge toner remaining on the surface of the latent electrostatic image bearing member after the transfer of images from the latent electrostatic image bearing member to a member in a subsequent step, and a developing unit 40K. This process cartridge is constructed in such a manner as to be detachably mountable to the main body of an image forming apparatus such as a copier or printer.

Here, operation of the process cartridge is explained. The latent electrostatic image bearing member 53K is rotationally driven at a predetermined circumferential velocity. While the latent electrostatic image bearing member 53K is rotated, the circumferential surface thereof is positively or negatively charged by the charging unit 57K in a uniform manner at a predetermined potential; subsequently, the charged circumferential surface receives image exposure light L emitted from an image exposing unit such as a unit employing slit exposure, laser beam scanning exposure, etc., and latent electrostatic images are sequentially formed on the surface of the latent electrostatic image bearing member 53K. Then the formed latent electrostatic images are developed with a toner by the developing unit 40K, and the developed images (toner images) are sequentially transferred by a transfer unit 66K to a transfer target material 61 fed from a paper feed unit (not shown) to the part between the latent electrostatic image bearing member 53K and the transfer unit 66K in synchronization with the rotation of the latent electrostatic image bearing member 53K.

The transfer target material 61 to which the images have been transferred is then separated from the surface of the latent electrostatic image bearing member and introduced to an image fixing unit so as to fix the images to the transfer target material 61, and subsequently the transfer target material 61 with the fixed images is printed out as a copy or a print to the outside of the apparatus.

On the surface of the latent electrostatic image bearing member 53K after the image transfer, residual toner which was not transferred is recharged by the charging member 60K that includes an elastic portion 58K and a conductive sheet 59K (formed of a conductive material) and that is configured to recharge toner remaining on the surface of the latent electrostatic image bearing member after the transfer of images from the latent electrostatic image bearing member to a member in a subsequent step. Then the toner is passed through the latent electrostatic image bearing member charging section, recovered in a developing step and repeatedly used for image formation.

The developing unit 40K includes a casing 41K, and a developing roller 42K, the circumferential surface of which is partially exposed from an opening provided in the casing 41K. Regarding the developing roller 42K serving as a developer bearing member, shafts protruding from both ends thereof with respect to the lengthwise direction are supported in a rotatable manner by respective bearings (not shown). The casing 41K houses a K toner, and the K toner is conveyed by a rotationally driven agitator 43K from the right side to the left side in the drawing. At the left side (in the drawing) of the agitator 43K, there is provided a toner supplying roller 44K which is rotationally driven in a counterclockwise direction (in the drawing) by a drive unit (not shown). The roller portion of this toner supplying roller 44K is made of an elastic foamed material such as a sponge and thus favorably receives the K toner sent from the agitator 43K.

The K toner received as just described is then supplied to the developing roller 42K through the contact portion between the toner supplying roller 44K and the developing roller 42K. The K toner borne on the surface of the developing roller 42K serving as a developer bearing member is regulated in terms of its layer thickness and effectively subjected to frictional charging when passing through the position where it comes into contact with a regulating blade 45K, as the developing roller 42K is rotationally driven in the counterclockwise direction (in the drawing). Thereafter, the K toner is conveyed to a developing region that faces the latent electrostatic image bearing member (photoconductor) 53K.

In view of adhesion of the toner, the charging member configured to recharge toner remaining on the surface of the latent electrostatic image bearing member after the transfer of images from the latent electrostatic image bearing member to a member in a subsequent step is preferably conductive because, if the charging member is insulative, the toner will adhere to it due to charge-up.

It is desirable that the charging member be a sheet made of a material selected from nylon, PTFE, PVDF and urethane. Particularly preferable among these are PTFE and PVDF in terms of chargeability of the toner.

The charging member preferably has a surface resistance of 10² Ω/sq. to 10⁸ Ω/sq. and a volume resistance of 10¹ Ω/sq. to 10⁶ Ω/sq.

The charging member is preferably in the form of a roller, a brush, a sheet, etc. In view of releasability of the attached toner, the charging member is particularly preferably in the form of a sheet.

In view of charging of the toner, the voltage applied to the charging member is preferably in the range of −1.4 kV to 0 kV.

In the case where the charging member is in the form of a conductive sheet, it is preferred (in view of the contact pressure between the charging member and the latent electrostatic image bearing member) that the thickness of the charging member be in the range of 0.05 mm to 0.5 mm.

Also, in view of the length of time of contact between the charging member and the latent electrostatic image bearing member when the toner is charged, it is preferred that the nip width (where the charging member is in contact with the latent electrostatic image bearing member) be in the range of 1 mm to 10 mm.

### (Image Forming Apparatus and Image Forming Method)

An image forming apparatus of the present invention includes: a latent image bearing member configured to bear a latent image; a charging unit configured to charge a surface of the latent image bearing member uniformly; an exposing unit configured to expose the charged surface of the latent image bearing member, based upon image data, so as to write a latent electrostatic image on the surface of the latent image bearing member; a developing unit configured to supply a toner to the latent electrostatic image formed on the surface of the latent image bearing member so as to make the latent electrostatic image into a visible image; a transfer unit configured to transfer the visible image on the surface of the latent image bearing member to a transfer target; and a fixing unit configured to fix the visible image on the transfer target. If necessary, the image forming apparatus may further include suitably selected other unit(s) such as a charge eliminating unit, a cleaning unit, a recycling unit, a controlling unit, etc.

An image forming method of the present invention includes the steps of: uniformly charging a surface of a latent image bearing member; exposing the charged surface of the latent image bearing member, based upon image data, so as to write a latent electrostatic image on the surface of the latent image bearing member; forming a developer layer of a predetermined layer thickness over a developer bearing member by means of a developer layer regulating member, and developing the latent electrostatic image on the surface of the latent image bearing member with use of the developer layer so as to make the latent electrostatic image into a visible image; transferring the visible image on the surface of the latent image bearing member to a transfer target; and fixing the visible image on the transfer target. Note that the image forming method includes at least latent electrostatic image forming steps (the charging step and the exposing step), the developing step, the transfer step and the fixing step, and may, if necessary, include suitably selected other step(s) such as a charge eliminating step, a cleaning step, a recycling step, a controlling step, etc.

The latent electrostatic image can be formed, for example, by uniformly charging the surface of the latent image bearing member by means of the charging unit and then exposing the surface imagewise by means of the exposing unit.

The formation of the visible image by the developing may specifically be as follows: a toner layer is formed on a developing roller serving as the developer bearing member, the toner layer on the developing roller is conveyed so as to come into contact with a photoconductor drum serving as the latent image bearing member, a latent electrostatic image on the photoconductor drum is thereby developed, and a visible image is thus formed.

The toner is agitated by an agitating unit and mechanically supplied to a developer supplying member.

The toner supplied from the developer supplying member and then deposited on the developer bearing member is formed into a uniform thin layer and charged, by passing through the developer layer regulating member provided in such a manner as to touch the surface of the developer bearing member.

The latent electrostatic image formed on the latent image bearing member is developed in a developing region by attachment of the charged toner thereto by means of the developing unit, and a toner image is thus formed.

For example, the visible image on the latent image bearing member (photoconductor) can be transferred by charging the latent image bearing member with the use of a transfer charger and can be transferred by the transfer unit.

The visible image transferred to a recording medium (transfer target) is fixed thereto using a fixing device (fixing unit). Toners of each color may be separately fixed upon their transfer to the recording medium. Alternatively, the toners of each color may be fixed at one time, being in a laminated state.

The fixing device is not particularly limited and may be suitably selected according to the intended purpose. Preference is given to a known heating and pressurizing unit.

Examples of the heating and pressurizing unit include a combination of a heating roller and a pressurizing roller, and a combination of a heating roller, a pressurizing roller and an endless belt.

In general, it is preferred that the temperature at which heating is performed by the heating and pressurizing unit be in the range of 80° C. to 200° C.

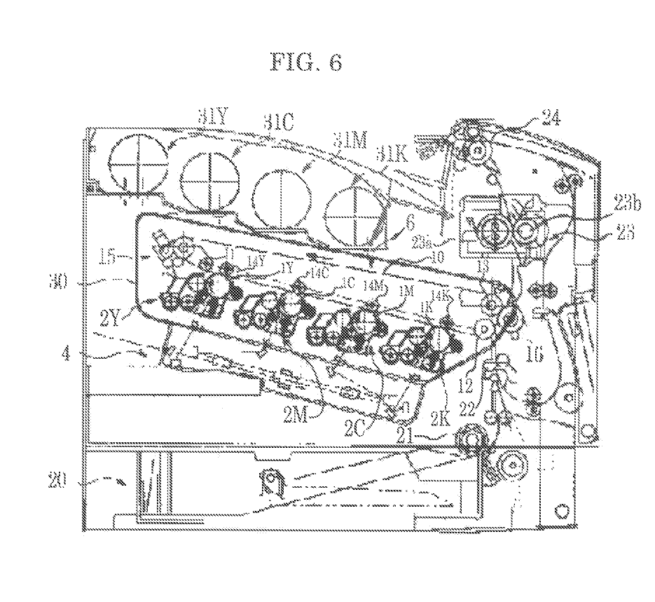

Next, the fundamental structure of an image forming apparatus (printer) according to an embodiment of the present invention will be further explained, referring to drawings. FIG. 6 is a schematic drawing showing the structure of an image forming apparatus according to an embodiment of the present invention. Here, an embodiment in which the image forming apparatus is used as an electrophotographic image forming apparatus is explained. The image forming apparatus forms a color image, using toners of four colors, i.e., yellow (hereinafter written as “Y”), cyan (hereinafter written as “C”), magenta (hereinafter written as “M”) and black (hereinafter written as “K”).

First of all, an explanation is given concerning the fundamental structure of an image forming apparatus (tandem-type image forming apparatus) including a plurality of latent image bearing members, wherein the latent image bearing members are aligned in the moving direction of a surface moving member. This image forming apparatus includes four photoconductors 1Y, 1C, 1M and 1K as the latent image bearing members. Note that although drum-like photoconductors are employed here as an example, belt-like photoconductors may be employed instead.

The photoconductors 1Y, 1C, 1M and 1K are rotationally driven in the direction of the arrows in the drawing, coming into contact with an intermediate transfer belt 10 that serves as the surface moving member. The photoconductors 1Y, 1C, 1M and 1K are each produced by forming a photosensitive layer over a relatively thin, cylindrical conductive substrate, and further, forming a protective layer over the photosensitive layer. Additionally, an intermediate layer may be provided between the photosensitive layer and the protective layer.

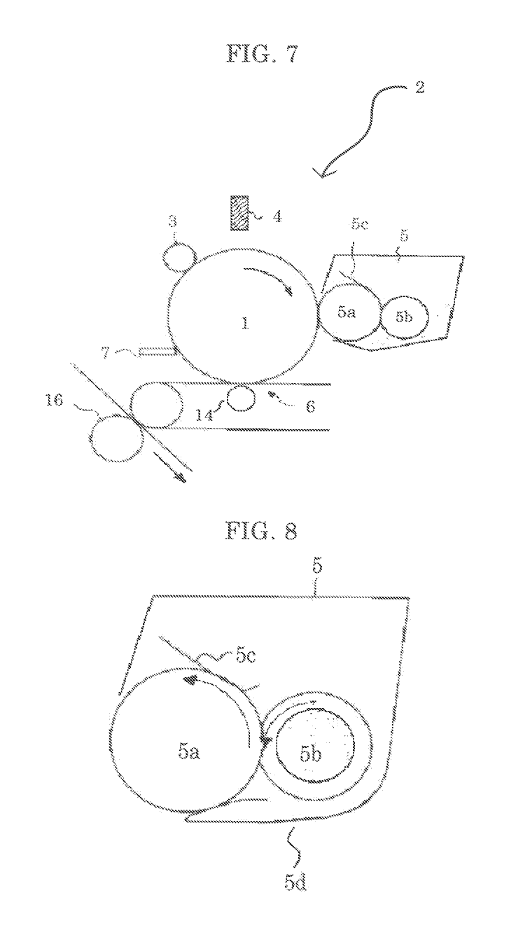

FIG. 7 is a schematic drawing showing the structure of an image forming unit 2 in which a photoconductor is placed. In FIG. 7, only one image forming unit 2 is shown and the symbols Y, C, M and K for referring to differences in color are omitted, on the grounds that the structures of the photoconductors 1Y, 1C, 1M and 1K and their surroundings in image forming units 2Y, 2C, 2M and 2K respectively are identical.

Around the photoconductor 1, the following members are disposed in the order mentioned, with respect to the direction in which the surface of the photoconductor 1 moves: a charging device 3 as the charging unit, a developing device 5 as the developing unit, a transfer device 6 as the transfer unit configured to transfer a toner image on the photoconductor 1 to a recording medium or the intermediate transfer belt 10, and a cleaning device 7 configured to remove untransferred toner on the photoconductor 1. Between the charging device 3 and the developing device 5, there is a space created such that light emitted from an exposing device 4 (which serves as the exposing unit configured to expose the charged surface of the photoconductor 1, based upon image data, so as to write a latent electrostatic image on the surface of the photoconductor 1) can pass through and reach as far as the photoconductor 1.

The charging device 3 charges the surface of the photoconductor 1 such that the surface has negative polarity. The charging device 3 in the present embodiment includes a charging roller serving as a charging member which performs charging in accordance with a contact or close-distance charging method. Specifically, this charging device 3 charges the surface of the photoconductor 1 by placing the charging roller so as to be in contact with or close to the surface of the photoconductor 1, and applying a bias of negative polarity to the charging roller. Such a direct-current charging bias as makes the photoconductor 1 have a surface potential of −500 V is applied to the charging roller. Additionally, a charging bias produced by superimposing an alternating-current bias onto a direct-current bias may be used as well.

The charging device 3 may be provided with a cleaning brush for cleaning the surface of the charging roller. Also regarding the charging device 3, a thin film may be wound around both ends (with respect to the axial direction) on the circumferential surface of the charging roller, and this film may be placed so as to touch the surface of the photoconductor 1.

In this structure, the surface of the charging roller and the surface of the photoconductor 1 are very close to each other, with the distance between them being equivalent to the thickness of the film. Thus, electric discharge is generated between the surface of the charging roller and the surface of the photoconductor 1 by the charging bias applied to the charging roller, and the surface of the photoconductor 1 is charged by means of the electric discharge.

The surface of the photoconductor 1 thus charged is exposed by the exposing device 4, and a latent electrostatic image corresponding to each color is formed on the surface of the photoconductor 1. This exposing device 4 writes a latent electrostatic image (which corresponds to each color) on the surface of the photoconductor 1 based upon image information (which corresponds to each color). Note that although the exposing device 4 in the present embodiment is of laser type, an exposing device of other type, which includes an LED array and an image forming unit, may be employed as well.

Each toner supplied from toner bottles 31Y, 31C, 31M and 31K into the developing device 5 is conveyed by a developer supplying roller 5b and then borne on a developing roller 5a. This developing roller 5a is conveyed to a region that faces the photoconductor 1 (hereinafter, this region will be referred to as “developing region”). In the developing region, the surface of the developing roller 5a moves in the same direction as and at a higher linear velocity than the surface of the photoconductor 1. Then, the toner on the developing roller 5a is supplied onto the surface of the photoconductor 1, rubbing against the surface of the photoconductor 1. At this time, a developing bias of −300V is applied from a power source (not shown) to the developing roller 5a, and thus a developing electric field is formed in the developing region. Between the latent electrostatic image on the photoconductor 1 and the developing roller 5a, electrostatic force which advances toward the latent electrostatic image acts on the toner borne on the developing roller 5a. Thus, the toner on the developing roller 5a is attached to the latent electrostatic image on the photoconductor 1. By this attachment, the latent electrostatic image on the photoconductor 1 is developed into a toner image corresponding to each color.

The intermediate transfer belt 10 in the transfer device 6 is set in a stretched manner on three supporting rollers 11, 12 and 13 and is configured to move endlessly in the direction of the arrow in the drawing. The toner images on the photoconductors 1Y, 1C, 1M and 1K are transferred by an electrostatic transfer method onto this intermediate transfer belt 10 such that the toner images are superimposed on one another.

The electrostatic transfer method may employ a structure with a transfer charger. Nevertheless, in this embodiment, a structure with a primary transfer roller 14, which causes less scattering of transferred toner, is employed.

Specifically, primary transfer rollers 14Y, 14C, 14M and 14K each serving as a component of the transfer device 6 are placed on the opposite side to the part of the intermediate transfer belt 10 which comes into contact with the photoconductors 1Y, 1C, 1M and 1K. Here, the part of the intermediate transfer belt 10 pressed by the primary transfer rollers 14Y, 14C, 14M and 14K, and the photoconductors 1Y, 1C, 1M and 1K constitute respective primary transfer nip portions. When the toner images on the photoconductors 1Y, 1C, 1M and 1K are transferred onto the intermediate transfer belt 10, a bias of positive polarity is applied to each primary transfer roller 14. Accordingly, a transfer electric field is formed at each primary transfer nip portion, and the toner images on the photoconductors 1Y, 1C, 1M and 1K are electrostatically attached onto the intermediate transfer belt 10 and thusly transferred.

A belt cleaning device 15 for removing toner which remains on the surface of the intermediate transfer belt 10 is provided in the vicinity of the intermediate transfer belt 10. Using a fur brush or a cleaning blade, this belt cleaning device 15 is configured to collect unnecessary toner attached to the surface of the intermediate transfer belt 10. Parenthetically, the collected unnecessary toner is conveyed from inside the belt cleaning device 15 to a waste toner tank (not shown) by a conveyance unit (not shown).

At the part where the intermediate transfer belt 10 is set in a stretched manner on the supporting roller 13, a secondary transfer roller 16 is placed so as to be in contact with the intermediate transfer belt 10. A secondary transfer nip portion is formed between the intermediate transfer belt 10 and the secondary transfer roller 16, and transfer paper as a recording medium is sent to this secondary transfer nip portion with predetermined timing. This transfer paper is stored in a paper feed cassette 20 situated below (in the drawing) the exposing device 4, then the transfer paper is transferred to the secondary transfer nip portion by a paper feed roller 21, a pair of registration rollers 22 and the like. At the secondary transfer nip portion, the toner images superimposed onto one another on the intermediate transfer belt 10 are transferred onto the transfer paper at one time. At the time of this secondary transfer, a bias of positive polarity is applied to the secondary transfer roller 16, and the toner images on the intermediate transfer belt 10 are transferred onto the transfer paper by means of a transfer electric field formed by the application of the bias.

A heat fixing device 23 serving as the fixing unit is placed downstream of the secondary transfer nip portion with respect to the direction in which the transfer paper is conveyed. This heat fixing device 23 includes a heating roller 23a with a heater incorporated therein, and a pressurizing roller 23b for applying pressure. The transfer paper which has passed through the secondary transfer nip portion receives heat and pressure, sandwiched between these rollers. This causes the toners on the transfer paper to melt, and a toner image is fixed to the transfer paper. The transfer paper to which the toner image has been fixed is discharged by a paper discharge roller 24 onto a paper discharge tray situated on an upper surface of the apparatus.

Regarding the developing device 5, the developing roller 5a serving as the developer bearing member is partially exposed from an opening of a casing of the developing device 5. Also, in this embodiment, a one-component developer including no carrier is used. The developing device 5 receives the toner (which corresponds to each color) supplied from the toner bottles 31Y, 31C, 31M and 31K (shown in FIG. 6) and stores it therein. These toner bottles 31Y, 31C, 31M and 31K are detachably mountable to the main body of the image forming apparatus such that they can be separately replaced. Due to such a structure, when any of the toners has run out, the corresponding toner bottle among the toner bottles 31Y, 31C, 31M and 31K can be replaced independently. Therefore, when any of the toners has run out, components other than the corresponding toner bottle, whose lifetimes have not yet ended, can continue being used, and thus the user can save costs.

FIG. 8 is a schematic drawing showing the structure of the developing device 5 shown in FIG. 7. The developer (toner) housed in a developer storing container is conveyed to a nip portion formed between the developing roller 5a (which serves as the developer bearing member configured to bear on its surface the developer to be supplied to the photoconductor 1) and the developer supplying roller 5b (which serves as the developer supplying member) while being agitated by the developer supplying roller 5b. At this time, the developer supplying roller 5b and the developing roller 5a rotate in opposite directions to each other (counter rotation) at the nip portion. The amount of the toner on the developing roller 5a is regulated by a regulating blade 5c (which serves as the developer layer regulating member) provided so as to touch the developing roller 5a, and a toner thin layer is thus formed on the developing roller 5a. Also, the toner is rubbed at the nip portion between the developer supplying roller 5b and the developing roller 5a and at the part between the regulating blade 5c and the developing roller 5a, and controlled so as to have an appropriate charge amount.

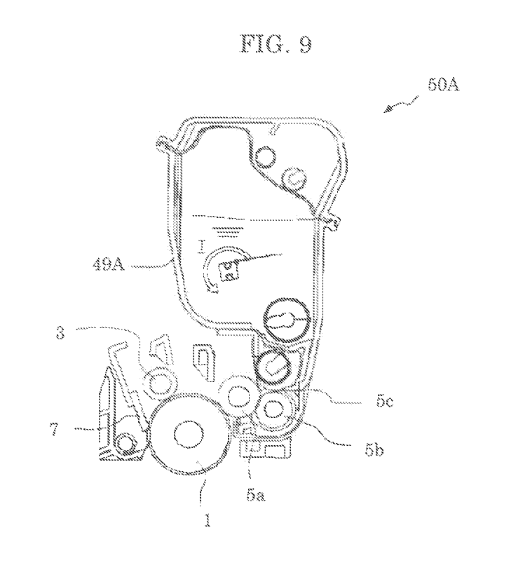

FIG. 9 is a schematic drawing showing the structure of a process cartridge. The developer according to the present invention can be used, for example, in an image forming apparatus provided with a process cartridge shown in FIG. 9. In FIG. 9, the sign 49A denotes a developer storing container, and the sign 50A denotes a process cartridge. In the present invention, among components such as a latent electrostatic image bearing member, a latent electrostatic image charging unit and a developing unit, a plurality of members constitute a single unit as a process cartridge, and this process cartridge is constructed in such a manner as to be detachably mountable to the main body of an image forming apparatus such as a copier or printer. The process cartridge 50A shown in FIG. 9 includes a latent electrostatic image bearing member 1, a latent electrostatic image charging unit 3, the developing unit (the developing roller 5a, the developer supplying roller 5b and the regulating blade 5c) explained in relation to FIG. 5, and a cleaning device 7.

### EXAMPLES

The following explains the present invention more specifically, referring to Examples and Comparative Examples. It should, however, be noted that the scope of the present invention is not confined to these Examples. Hereinafter, the term “parts” will be used to mean “parts by mass”.

### (Production of Vinyl Resin Fine Particle Dispersion Liquid 1)

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.6 parts of potassium persulfate was dissolved in 104 parts of ion-exchange water was added. Fifteen minutes after, a monomer mixed liquid composed of 200 parts of a styrene monomer and 8.2 parts of n-octanethiol was dripped for 90 minutes, then the temperature was kept at 80° C. for a further 60 minutes to allow a polymerization reaction to proceed.

Thereafter, cooling was carried out, and Vinyl Resin Fine Particle Dispersion Liquid 1 that was white in color was thus obtained. The Vinyl Resin Fine Particles 1 obtained from Vinyl Resin Fine Particle Dispersion Liquid 1 had a volume average particle diameter (Mv) of 121 nm. Two milliliters of the obtained dispersion liquid was placed in a Petri dish, then the dispersion medium was evaporated, and dried matter was thus obtained. The dried matter had a number average molecular weight of 8,200, a weight average molecular weight of 15,600 and a Tg of 83° C.

### (Production of Vinyl Resin Fine Particle Dispersion Liquid 2)

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.6 parts of potassium persulfate was dissolved in 104 parts of ion-exchange water was added. Fifteen minutes after, a monomer mixed liquid composed of 200 parts of a styrene monomer and 16.8 parts of n-octanethiol was dripped for 90 minutes, then the temperature was kept at 80° C. for a further 60 minutes to allow a polymerization reaction to proceed.

Thereafter, cooling was carried out, and Vinyl Resin Fine Particle Dispersion Liquid 2 that was white in color was thus obtained. The Vinyl Resin Fine Particles 2 obtained from Vinyl Resin Fine Particle Dispersion Liquid 2 had a volume average particle diameter (Mv) of 133 nm. Two milliliters of the obtained dispersion liquid was placed in a Petri dish, then the dispersion medium was evaporated, and dried matter was thus obtained. The dried matter had a number average molecular weight of 4,800, a weight average molecular weight of 8,500 and a Tg of 62° C.

### (Production of Vinyl Resin Fine Particle Dispersion Liquid 3)

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.6 parts of potassium persulfate was dissolved in 104 parts of ion-exchange water was added. Fifteen minutes after, a monomer mixed liquid composed of 191 parts of a styrene monomer, 4 parts of butyl acrylate, 5 parts of methacrylic acid and 9.6 parts of n-octanethiol was dripped for 90 minutes, then the temperature was kept at 80° C. for a further 60 minutes to allow a polymerization reaction to proceed.

Thereafter, cooling was carried out, and Vinyl Resin Fine Particle Dispersion Liquid 3 that was white in color was thus obtained. The Vinyl Resin Fine Particles 3 obtained from Vinyl Resin Fine Particle Dispersion Liquid 3 had a volume average particle diameter (Mv) of 120 nm. Two milliliters of the obtained dispersion liquid was placed in a Petri dish, then the dispersion medium was evaporated, and dried matter was thus obtained. The dried matter had a number average molecular weight of 11,000, a weight average molecular weight of 15,100 and a Tg of 81° C.

### (Production of Vinyl Resin Fine Particle Dispersion Liquid 4)

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.6 parts of potassium persulfate was dissolved in 103 parts of ion-exchange water was added. Fifteen minutes after, a monomer mixed liquid composed of 170 parts of a styrene monomer, 20 parts of butyl acrylate, 10 parts of methacrylic acid and 9.4 parts of n-octanethiol was dripped for 90 minutes, then the temperature was kept at 80° C. for a further 60 minutes to allow a polymerization reaction to proceed.

Thereafter, cooling was carried out, and Vinyl Resin Fine Particle Dispersion Liquid 4 that was white in color was thus obtained. The Vinyl Resin Fine Particles 4 obtained from Vinyl Resin Fine Particle Dispersion Liquid 4 had a volume average particle diameter (Mv) of 80 nm. Two milliliters of the obtained dispersion liquid was placed in a Petri dish, then the dispersion medium was evaporated, and dried matter was thus obtained. The dried matter had a number average molecular weight of 11,500, a weight average molecular weight of 15,000 and a Tg of 79° C.

### (Production of Vinyl Resin Fine Particle Dispersion Liquid 5)

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.6 parts of potassium persulfate was dissolved in 104 parts of ion-exchange water was added. Fifteen minutes after, a monomer mixed liquid composed of 200 parts of a styrene monomer and 7.4 parts of n-octanethiol was dripped for 90 minutes, then the temperature was kept at 80° C. for a further 60 minutes to allow a polymerization reaction to proceed.

Thereafter, cooling was carried out, and Vinyl Resin Fine Particle Dispersion Liquid 5 that was white in color was thus obtained. The Vinyl Resin Fine Particles 5 obtained from Vinyl Resin Fine Particle Dispersion Liquid 5 had a volume average particle diameter (Mv) of 110 nm. Two milliliters of the obtained dispersion liquid was placed in a Petri dish, then the dispersion medium was evaporated, and dried matter was thus obtained. The dried matter had a number average molecular weight of 12,200, a weight average molecular weight of 18,900 and a Tg of 99° C.

### (Production of Vinyl Resin Fine Particle Dispersion Liquid 6)

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.6 parts of potassium persulfate was dissolved in 104 parts of ion-exchange water was added. Fifteen minutes after, a monomer mixed liquid composed of 200 parts of a styrene monomer and 19.6 parts of n-octanethiol was dripped for 90 minutes, then the temperature was kept at 80° C. for a further 60 minutes to allow a polymerization reaction to proceed.

Thereafter, cooling was carried out, and Vinyl Resin Fine Particle Dispersion Liquid 6 that was white in color was thus obtained. The Vinyl Resin Fine Particles 6 obtained from Vinyl Resin Fine Particle Dispersion Liquid 6 had a volume average particle diameter (Mv) of 140 nm. Two milliliters of the obtained dispersion liquid was placed in a Petri dish, then the dispersion medium was evaporated, and dried matter was thus obtained. The dried matter had a number average molecular weight of 4,000, a weight average molecular weight of 7,500 and a Tg of 55° C.

### (Production of Vinyl Resin Fine Particle Dispersion Liquid 7)

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.6 parts of potassium persulfate was dissolved in 104 parts of ion-exchange water was added. Fifteen minutes after, a monomer mixed liquid composed of 200 parts of a styrene monomer and 7 parts of n-octanethiol was dripped for 90 minutes, then the temperature was kept at 80° C. for a further 60 minutes to allow a polymerization reaction to proceed.

Thereafter, cooling was carried out, and Vinyl Resin Fine Particle Dispersion Liquid 7 that was white in color was thus obtained. The Vinyl Resin Fine Particles 7 obtained from Vinyl Resin Fine Particle Dispersion Liquid 7 had a volume average particle diameter (Mv) of 108 nm. Two milliliters of the obtained dispersion liquid was placed in a Petri dish, then the dispersion medium was evaporated, and dried matter was thus obtained. The dried matter had a number average molecular weight of 13,800, a weight average molecular weight of 20,000 and a Tg of 105° C.

### (Production of Vinyl Resin Fine Particle Dispersion Liquid 8)

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.6 parts of potassium persulfate was dissolved in 104 parts of ion-exchange water was added. Fifteen minutes after, a monomer mixed liquid composed of 200 parts of a styrene monomer and 20 parts of n-octanethiol was dripped for 90 minutes, then the temperature was kept at 80° C. for a further 60 minutes to allow a polymerization reaction to proceed.

Thereafter, cooling was carried out, and Vinyl Resin Fine Particle Dispersion Liquid 8 that was white in color was thus obtained. The Vinyl Resin Fine Particles 8 obtained from Vinyl Resin Fine Particle Dispersion Liquid 8 had a volume average particle diameter (Mv) of 145 nm. Two milliliters of the obtained dispersion liquid was placed in a Petri dish, then the dispersion medium was evaporated, and dried matter was thus obtained. The dried matter had a number average molecular weight of 3,500, a weight average molecular weight of 7,000 and a Tg of 52° C.

### (Production of Vinyl Resin Fine Particle Dispersion Liquid 9)

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.6 parts of potassium persulfate was dissolved in 103 parts of ion-exchange water was added. Fifteen minutes after, a monomer mixed liquid composed of 170 parts of a styrene monomer, 30 parts of butyl acrylate and 8.2 parts of n-octanethiol was dripped for 90 minutes, then the temperature was kept at 80° C. for a further 60 minutes to allow a polymerization reaction to proceed.

Thereafter, cooling was carried out, and Vinyl Resin Fine Particle Dispersion Liquid 9 that was white in color was thus obtained. The Vinyl Resin Fine Particles 9 obtained from Vinyl Resin Fine Particle Dispersion Liquid 9 had a volume average particle diameter (Mv) of 100 nm. Two milliliters of the obtained dispersion liquid was placed in a Petri dish, then the dispersion medium was evaporated, and dried matter was thus obtained. The dried matter had a number average molecular weight of 8,300, a weight average molecular weight of 15,900 and a Tg of 55° C.

### (Production of Vinyl Resin Fine Particle Dispersion Liquid 10)

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.6 parts of potassium persulfate was dissolved in 103 parts of ion-exchange water was added. Fifteen minutes after, a monomer mixed liquid composed of 200 parts of a styrene monomer and 12 parts of n-octanethiol was dripped for 90 minutes, then the temperature was kept at 80° C. for a further 60 minutes to allow a polymerization reaction to proceed.

Thereafter, cooling was carried out, and Vinyl Resin Fine Particle Dispersion Liquid 10 that was white in color was thus obtained. The Vinyl Resin Fine Particles 10 obtained from Vinyl Resin Fine Particle Dispersion Liquid 10 had a volume average particle diameter (Mv) of 90 nm. Two milliliters of the obtained dispersion liquid was placed in a Petri dish, then the dispersion medium was evaporated, and dried matter was thus obtained. The dried matter had a number average molecular weight of 5,900, a weight average molecular weight of 10,600 and a Tg of 68° C.

### (Production of Vinyl Resin Fine Particle Dispersion Liquid 11)

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.6 parts of potassium persulfate was dissolved in 103 parts of ion-exchange water was added. Fifteen minutes after, a monomer mixed liquid composed of 160 parts of a styrene monomer, 40 parts of butyl acrylate and 7.4 parts of n-octanethiol was dripped for 90 minutes, then the temperature was kept at 80° C. for a further 60 minutes to allow a polymerization reaction to proceed.

Thereafter, cooling was carried out, and Vinyl Resin Fine Particle Dispersion Liquid 11 that was white in color was thus obtained. The Vinyl Resin Fine Particles 11 obtained from Vinyl Resin Fine Particle Dispersion Liquid 11 had a volume average particle diameter (Mv) of 92 nm. Two milliliters of the obtained dispersion liquid was placed in a Petri dish, then the dispersion medium was evaporated, and dried matter was thus obtained. The dried matter had a number average molecular weight of 8,500, a weight average molecular weight of 15,800 and a Tg of 58° C.

### (Production of Vinyl Resin Fine Particle Dispersion Liquid 12)

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.6 parts of potassium persulfate was dissolved in 103 parts of ion-exchange water was added. Fifteen minutes after, a monomer mixed liquid composed of 180 parts of a styrene monomer, 20 parts of butyl acrylate and 9.6 parts of n-octanethiol was dripped for 90 minutes, then the temperature was kept at 80° C. for a further 60 minutes to allow a polymerization reaction to proceed.

Thereafter, cooling was carried out, and Vinyl Resin Fine Particle Dispersion Liquid 12 that was white in color was thus obtained. The Vinyl Resin Fine Particles 12 obtained from Vinyl Resin Fine Particle Dispersion Liquid 12 had a volume average particle diameter (Mv) of 100 nm. Two milliliters of the obtained dispersion liquid was placed in a Petri dish, then the dispersion medium was evaporated, and dried matter was thus obtained. The dried matter had a number average molecular weight of 7,600, a weight average molecular weight of 13,500 and a Tg of 74° C.

### (Production of Vinyl Resin Fine Particle Dispersion Liquid 13)

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.6 parts of potassium persulfate was dissolved in 103 parts of ion-exchange water was added. Fifteen minutes after, a monomer mixed liquid composed of 194 parts of a styrene monomer, 6 parts of methacrylic acid and 7 parts of n-octanethiol was dripped for 90 minutes, then the temperature was kept at 80° C. for a further 60 minutes to allow a polymerization reaction to proceed.

Thereafter, cooling was carried out, and Vinyl Resin Fine Particle Dispersion Liquid 13 that was white in color was thus obtained. The Vinyl Resin Fine Particles 13 obtained from Vinyl Resin Fine Particle Dispersion Liquid 13 had a volume average particle diameter (Mv) of 111 nm. Two milliliters of the obtained dispersion liquid was placed in a Petri dish, then the dispersion medium was evaporated, and dried matter was thus obtained. The dried matter had a number average molecular weight of 8,800, a weight average molecular weight of 15,900 and a Tg of 98° C.

### (Production of Vinyl Resin Fine Particle Dispersion Liquid 14)

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.6 parts of potassium persulfate was dissolved in 103 parts of ion-exchange water was added. Fifteen minutes after, a monomer mixed liquid composed of 194 parts of a styrene monomer, 6 parts of methacrylic acid and 8 parts of n-octanethiol was dripped for 90 minutes, then the temperature was kept at 80° C. for a further 60 minutes to allow a polymerization reaction to proceed.

Thereafter, cooling was carried out, and Vinyl Resin Fine Particle Dispersion Liquid 14 that was white in color was thus obtained. The Vinyl Resin Fine Particles 14 obtained from Vinyl Resin Fine Particle Dispersion Liquid 14 had a volume average particle diameter (Mv) of 98 nm. Two milliliters of the obtained dispersion liquid was placed in a Petri dish, then the dispersion medium was evaporated, and dried matter was thus obtained. The dried matter had a number average molecular weight of 8,700, a weight average molecular weight of 15,700 and a Tg of 103° C.

### (Production of Vinyl Resin Fine Particle Dispersion Liquid 15)

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.6 parts of potassium persulfate was dissolved in 103 parts of ion-exchange water was added. Fifteen minutes after, a monomer mixed liquid composed of 150 parts of a styrene monomer, 50 parts of butyl acrylate and 12 parts of n-octanethiol was dripped for 90 minutes, then the temperature was kept at 80° C. for a further 60 minutes to allow a polymerization reaction to proceed.

Thereafter, cooling was carried out, and Vinyl Resin Fine Particle Dispersion Liquid 15 that was white in color was thus obtained. The Vinyl Resin Fine Particles 15 obtained from Vinyl Resin Fine Particle Dispersion Liquid 15 had a volume average particle diameter (Mv) of 100 nm. Two milliliters of the obtained dispersion liquid was placed in a Petri dish, then the dispersion medium was evaporated, and dried matter was thus obtained. The dried matter had a number average molecular weight of 5,900, a weight average molecular weight of 10,600 and a Tg of 51° C.

The monomer compositions and physical properties of the vinyl resin fine particles obtained as described above are shown in Table 1-1.

### (Synthesis of Polyester 1)

In a reaction container equipped with a condenser tube, a stirrer and a nitrogen-introducing tube, 229 parts of an ethylene oxide (2 mol) adduct of bisphenol A, 529 parts of a propylene oxide (2 mol) adduct of bisphenol A, 208 parts of terephthalic acid, 46 parts of adipic acid and 2 parts of dibutyltin oxide were placed. Subsequently, the ingredients were reacted together for 8 hours at normal pressure and at 230° C., then further reacted together for 5 hours at a reduced pressure of 10 mmHg to 15 mmHg. Thereafter, 44 parts of trimellitic anhydride was poured into the reaction container, then the ingredients were reacted together for 2 hours at normal pressure and at 180° C., and Polyester 1 was thus synthesized.

Polyester 1 had a number average molecular weight of 2,500, a weight average molecular weight of 6,700, a Tg of 43° C. and an acid value of 24 mgKOH/g.

### (Synthesis of Polyester 2)

In a reaction container equipped with a condenser tube, a stirrer and a nitrogen-introducing tube, 270 parts of an ethylene oxide (2 mol) adduct of bisphenol A, 497 parts of a propylene oxide (2 mol) adduct of bisphenol A, 110 parts of terephthalic acid, 102 parts of isophthalic acid, 44 parts of adipic acid and 2 parts of dibutyltin oxide were placed. Subsequently, the ingredients were reacted together for 9 hours at normal pressure and at 230° C. Next, the ingredients were reacted together for 7 hours at a reduced pressure of 10 mmHg to 18 mmHg. Thereafter, 40 parts of trimellitic anhydride was poured into the reaction container, then the ingredients were reacted together for 2 hours at normal pressure and at 180° C., and Polyester 2 was thus synthesized.

Polyester 2 had a number average molecular weight of 3,000, a weight average molecular weight of 8,600, a Tg of 49° C. and an acid value of 22 mgKOH/g.

### (Synthesis of Polyester 3)

In a reaction container equipped with a condenser tube, a stirrer and a nitrogen-introducing tube, 218 parts of an ethylene oxide (2 mol) adduct of bisphenol A, 460 parts of a propylene oxide (2 mol) adduct of bisphenol A, 140 parts of terephthalic acid, 145 parts of isophthalic acid and 2 parts of dibutyltin oxide were placed. Subsequently, the ingredients were reacted together for 8 hours at normal pressure and at 230° C. Next, the ingredients were reacted together for 6 hours at a reduced pressure of 10 mmHg to 18 mmHg. Thereafter, 24 parts of trimellitic anhydride was poured into the reaction container, then the ingredients were reacted together for 2 hours at normal pressure and at 180° C., and Polyester 3 was thus synthesized.

Polyester 3 had a number average molecular weight of 7,600, a weight average molecular weight of 21,000, a Tg of 57° C. and an acid value of 15 mgKOH/g.

### (Synthesis of Isocyanate-Modified Polyester (Prepolymer))

In a reaction container equipped with a condenser tube, a stirrer and a nitrogen-introducing tube, 682 parts of an ethylene oxide (2 mol) adduct of bisphenol A, 81 parts of a propylene oxide (2 mol) adduct of bisphenol A, 283 parts of terephthalic acid, 22 parts of trimelllitic anhydide and 2 parts of dibutyltin oxide were placed. Subsequently, the ingredients were reacted together for 8 hours at normal pressure and at 230° C., then further reacted together for 5 hours at a reduced pressure of 10 mmHg to 15 mmHg, and Intermediate Polyester 1 was thus obtained. Intermediate Polyester 1 had a number average molecular weight of 2,100, a weight average molecular weight of 9,500, a Tg of 55° C., an acid value of 0.5 mgKOH/g and a hydroxyl value of 49 mgKOH/g.

Next, in a reaction container equipped with a condenser tube, a stirrer and a nitrogen-introducing tube, 411 parts of Intermediate Polyester 1, 89 parts of isophorone diisocyanate and 500 parts of ethyl acetate were placed. Subsequently, the ingredients were reacted together for 5 hours at 100° C., and Isocyanate-modified Polyester 1 was thus obtained. The free isocyanate content of Isocyanate-modified Polyester 1 was 1.53% by mass.

### (Masterbatch 1)

Using a Henschel mixer, 40 parts of Pigment Blue 15:3, 60 parts of Polyester 1 and 30 parts of water were mixed together, and a mixture in which water had soaked into a pigment aggregate was thus obtained. This mixture was kneaded for 45 minutes, using a two roll mill with the roll surface temperature being set at 130° C., then the kneaded mixture was pulverized so as to have a size of 1 mm, using a pulverizer, and Master Batch 1 was thus obtained.

### Example 1

### Aqueous Phase Producing Step

Nine hundred and seventy parts of ion-exchange water, 40 parts of a 25% (by mass) aqueous dispersion liquid of organic resin fine particles (a copolymer of styren-methacrylic acid-butyl acrylate-sodium salt of methacrylic acid ethylene oxide adduct sulfate ester) for dispersion stability, 95 parts of a 48.5% (by mass) aqueous solution of sodium dodecyl diphenyl ether disulfonate, and 98 parts of ethyl acetate were mixed and stirred. The mixture had a pH of 6.2. Then the pH was adjusted to 9.5 by dripping a 10% (by mass) sodium hydroxide aqueous solution, and Aqueous Phase 1 was thus obtained.

### <Oil Phase Producing Step>

In a container equipped with a stirring rod and a thermometer, 545 parts of Polyester 1, 181 parts of a paraffin wax (melting point: 74° C.) and 1,450 parts of ethyl acetate were placed. While the ingredients were being stirred, the temperature was increased to 80° C. The temperature was kept at 80° C. for 5 hours, and then cooled to 30° C. in 1 hour. Subsequently, 500 parts of Master Batch 1 and 100 parts of ethyl acetate were poured into the container, which was followed by mixing for 1 hour, and Raw Material Solution 1 was thus obtained.

Then 1,500 parts of Raw Material Solution 1 was moved into another container, and the pigment and the wax were dispersed using a bead mill (ULTRA VISCO MILL, manufactured by AIMEX CO., Ltd.) under the following conditions: the liquid sending rate was 1 kg/hr, the disc circumferential velocity was 6 m/sec, zirconia beads having a size of 0.5 mm each were supplied so as to occupy 80% by volume, and the ingredients were passed three times.

Subsequently, 655 parts of a 66% (by mass) ethyl acetate solution of Polyester 1 was added, and the mixture was passed once using the bead mill under the above conditions, and Pigment and Wax Dispersion Liquid 1 was thus obtained. Using T.K. HOMO MIXER (manufactured by Tokushu Kika Kogyo Co., Ltd.), 976 parts of Pigment and Wax Dispersion Liquid 1 was subjected to mixing at a rotational speed of 5,000 rpm for 1 minute. Thereafter, 88 parts of Isocyanate-modified Polyester 1 was added, then the ingredients were mixed together using T.K. HOMO MIXER (manufactured by Tokushu Kika Kogyo Co., Ltd.) at a rotational speed of 5,000 rpm for 1 minute, and Oil Phase 1 was thus obtained. Oil Phase 1 had a solid content of 52% by mass, and the amount of the ethyl acetate relative to the solid content was 92% by mass.

### <Core Particle Producing Step>

To Oil Phase 1 obtained, 1,200 parts of Aqueous phase 1 was added. Then the liquid temperature was adjusted to the range of 20° C. to 23° C. by cooling with a water bath in order to suppress temperature increase caused by the shear heat of a mixer; while doing so, the ingredients were mixed together for 2 minutes using T.K. HOMO MIXER with its rotational speed adjusted to the range of 8,000 rpm to 15,000 rpm, then the ingredients were stirred for 10 minutes using a three-one motor equipped with anchor blades, with its rotational speed adjusted to the range of 130 rpm to 350 rpm, and Core Particle Slurry 1, in which droplets of the oil phase to form core particles were dispersed in the aqueous phase, was thus obtained.

### <Step of Attaching Resin Fine Particles>

Core Particle Slurry 1 was stirred using a three-one motor equipped with anchor blades, with its rotational speed adjusted to the range of 130 rpm to 350 rpm; while doing so, a mixture (solid content concentration: 15% by mass) composed of 106 parts of Vinyl Resin Fine Particle Dispersion Liquid 1 and 71 parts of ion-exchange water was dripped for 3 minutes, with the liquid temperature set at 22° C. After the dripping, stirring was continued for 30 minutes with the rotational speed being adjusted to the range of 200 rpm to 450 rpm, and Composite Particle Slurry 1 was thus obtained. When 1 mL of Composite Particle Slurry 1 was collected, diluted to 10 mL and then centrifuged, the supernatant liquid was transparent.

### <Solvent Removing Step>

In a container equipped with a stirrer and a thermometer, Composite Particle Slurry 1 was placed, then the solvent was removed at 30° C. in 8 hours, while the ingredients were being stirred, and Dispersion Slurry 1 was thus obtained. When 1 mL of Dispersion Slurry 1 was collected, diluted to 10 mL and then centrifuged, the supernatant liquid was transparent.

### <Washing and Drying Step>

After 100 parts of Dispersion Slurry 1 was filtered under reduced pressure, the following operations were carried out.

(1) To the filter cake, 100 parts of ion-exchange water was added, then mixing was carried out using T.K. HOMO MIXER (rotational speed: 12,000 rpm, length of time: 10 minutes), and subsequently filtration was carried out.
(2) To the filter cake obtained by (1), 900 parts of ion-exchange water was added, then mixing was carried out using T.K. HOMO MIXER (rotational speed: 12,000 rpm, length of time: 30 minutes) with the provision of ultrasonic vibration, and subsequently filtration was carried out under reduced pressure. This process was repeated such that the electrical conductivity of the reslurry liquid became 10 μC/cm or less.
(3) To allow the pH of the reslurry liquid obtained by (2) to become 4, 10% (by mass) hydrochloric acid was added, then stirring was carried out for 30 minutes using a three-one motor, and subsequently filtration was carried out.
(4) To the filter cake obtained by (3), 100 parts of ion-exchange water was added, then mixing was carried out using T.K. HOMO MIXER (rotational speed: 12,000 rpm, length of time: 10 minutes), and subsequently filtration was carried out. This process was repeated such that the electrical conductivity of the reslurry liquid became 10 μC/cm or less, and Filter Cake 1 was thus obtained.

Filter Cake 1 was dried at 45° C. for 48 hours using a wind circulation dryer and then sieved using a mesh with a sieve mesh size of 75 μm, and Colored Resin Fine Particles 1 (volume average particle diameter (Dv): 6.1 μm, Dv/Dn=1.14), hereinafter referred to also as “base toner”, were thus obtained. When Colored Resin Fine Particles 1 were observed using a scanning electron microscope, it was confirmed that the vinyl resin was uniformly attached to the surfaces of the core particles and protruding portions were favorably formed.

Subsequently, 1.5 parts of hydrophobic silica (H2000/4, manufactured by Clariant, 12 nm in particle diameter) and 0.5 parts of hydrophobic silica (RX50, manufactured by Nippon Aerosil Co., Ltd., 40 nm in particle diameter) were mixed with 100 parts of the base toner using a Henschel mixer, and Toner 1 of Example 1 was thus obtained.

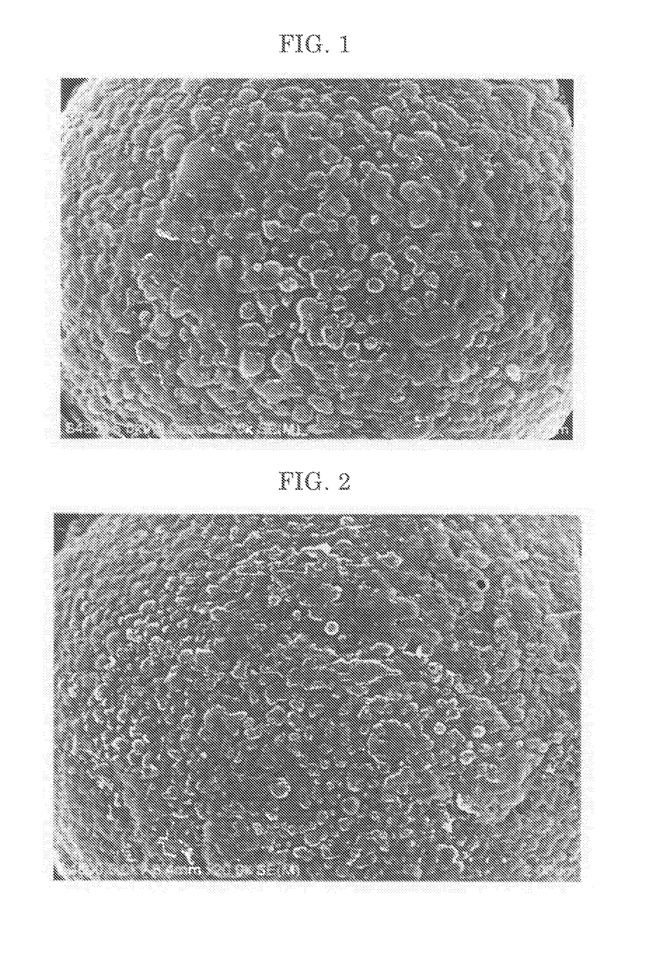

The result of the observation of the external appearance of a colored resin fine particle of Toner 1, using a scanning electron microscope, is shown in FIG. 1.

### Examples 2 to 13 and Comparative Examples 1 to 5

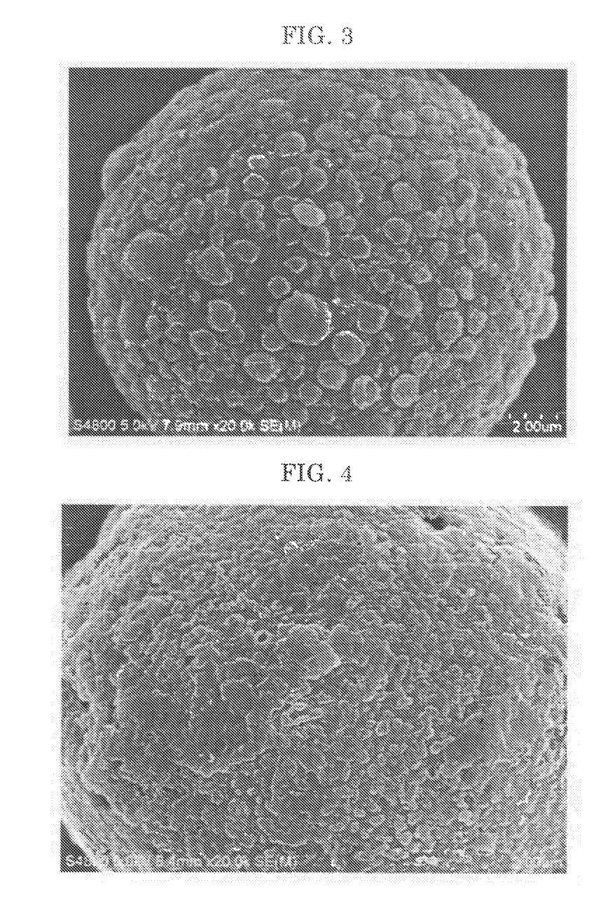

In Examples 2 to 13 and Comparative Examples 1 to 5, Toners 2 to 18 were respectively obtained in the same manner as in Example 1, provided that vinyl resin fine particle dispersion liquids and binder resins were used as shown in Tables 1-1 and 1-2. The result of an observation of a cross section of a colored resin fine particle of Toner 2, using a scanning electron microscope, is shown in FIG. 2. Regarding this colored resin fine particle, the vinyl resin fine particles were uniformly attached to the surface of the core particle and protruding portions were favorably formed. The result of an observation of the external appearance of a colored resin fine particle of Toner 9, using a scanning electron microscope, is shown in FIG. 3. The result of an observation of a cross section of a colored resin fine particle of Toner 10, using a scanning electron microscope, is shown in FIG. 4. The compositions of the toners used in Examples and Comparative Examples are shown in Tables 1-1 and 1-2.

### (Evaluation)

The following measurements were carried out to evaluate the toners produced in Examples 1 to 13 and Comparative Examples 1 to 5. The results are shown in Table 2.

### <Measurement of Particle Diameter of Vinyl Resin Fine Particles>

The particle diameters of the vinyl resin fine particles used in Examples 1 to 13 and Comparative Examples 1 to 5 were measured using UPA-150EX (manufactured by NIKKISO CO., LTD.).

### <Measurement of Molecular Weight of Vinyl Resin (GPC)>

The molecular weights of the vinyl resins used in Examples 1 to 13 and Comparative Examples 1 to 5 were measured by GPC (gel permeation chromatography) under the following conditions.

Apparatus: GPC-150C (manufactured by Waters Corporation)

Column: SHODEX GPC KF-801 to KF-807 (manufactured by Showa Denko K.K.)

Temperature: 40° C.

Solvent: THF (tetrahydrofuran)

Flow rate: 1.0 mL/min

Sample: 0.1 mL of a sample having a concentration of 0.05% by mass to 0.6% by mass was injected.

Using a molecular weight calibration curve produced with monodisperse polystyrene standard samples, based upon the molecular weight distribution of each resin measured under the above conditions, the number average molecular weight and the weight average molecular weight of each resin were calculated. As the polystyrene standard samples for producing the calibration curve, SHODEX STANDARD Std. Nos. S-7300, S-210, S-390, S-875, S-1980, S-10.9, S-629, S-3.0 and S-0.580, and toluene were used. As a detector, an RI (refractive index) detector was used.

### <Measurement of Glass Transition Temperature (Tg) of Vinyl Resin Fine Particles (DSC)>

As an apparatus for measuring the glass transition temperatures (Tg) of the vinyl resin fine particles used in Examples 1 to 13 and Comparative Examples 1 to 5, TG-DSC SYSTEM TAS-100 (manufactured by Rigaku Electric Corporation) was used. First, approximately 10 mg of a sample was placed in an aluminum container that was subsequently mounted on a holder unit and then set in an electric furnace. DSC measurement was carried out as follows: after heated to 150° C. from room temperature at a temperature increase rate of 10° C./min, the sample was left to stand at 150° C. for 10 minutes, then cooled to room temperature, left to stand for 10 minutes and subsequently heated to 150° C. again at a temperature increase rate of 10° C./min in a nitrogen atmosphere. The Tg was calculated from the point of tangency between a base line and a tangent to an endothermic curve in the vicinity of the glass transition temperature, using an analyzing system in TAS-100.

### <Measurement of Acid Value of Binder Resin>

The acid value of each of the binder resins used in Examples 1 to 13 and Comparative Examples 1 to 5 was measured based upon JIS K1557-1970. The following is a specific measuring method.

The amount of a sample as a pulverized product was precisely weighed and adjusted to approximately 2 g (W (g)).

The sample was poured into a 200 mL conical flask, then 100 mL of a mixed solution of toluene and ethanol (with the ratio of the toluene to the ethanol being 2:1) was added. The sample was dissolved in the mixed solution for 5 hours, then a phenolphthalein solution was added as an indicator.

Using a 0.1 N potassium hydroxide alcohol solution, the solution obtained as described above was titrated with a burette. The amount of the KOH solution at this time was denoted by S (mL). A blank test was carried out, and the amount of the KOH solution at this time was denoted by B (mL).

The acid value was calculated from the following equation.

Acid value=[(S−B)×f×5.61]/W

(f: factor of KOH solution)

For example, the acid value in the case where 90 parts of Polyester 1 (acid value: 24) and 10 parts of Isocyanate-modified Polyester 1 (acid value: 0.5) are used can be calculated as follows.

24(Acid value)×0.9+0.5(Acid value)×0.1=21.65

### <Measurement of Hydroxyl Value of Binder Resin>

The hydroxyl value of each of the binder resins used in Examples 1 to 13 and Comparative Examples 1 to 5 was measured based upon JIS K0070-1966.

The amount of a sample was precisely weighed and adjusted to 0.5 g and the sample was placed in a 100 mL eggplant-shaped flask, then 5 mL of an acetylating reagent was added to the sample.

Thereafter, the flask was placed in a bath at a temperature of 100° C.±5° C. to perform heating.

One to two hours later, the flask was removed from the bath and cooled, then ion-exchange water was added and shaking was carried out to decompose acetic anhydride.

Further, to complete decomposition thereof, the flask was again heated in a bath for 10 minutes or more and then cooled, and subsequently the wall of the flask was thoroughly washed with organic solvent.

The obtained liquid was subjected to potentiometric titration with an N/2 potassium hydroxide ethyl alcohol solution, using a glass electrode, and the hydroxyl value was calculated.

### <Measurement of Solid Content Concentration of Oil Phase>

The solid content concentration of each of the oil phases used in Examples 1 to 13 and Comparative Examples 1 to 5 was measured as follows.

Approximately 2 g of an oil phase was placed within 30 seconds on an aluminum dish (approximately 1 g to approximately 3 g) whose mass had been precisely weighed in advance, then the mass of the oil phase placed was precisely weighed. The aluminum dish and the oil phase were placed for 1 hour in an oven set at 150° C. to evaporate the solvent, then removed from the oven and left to stand so as to be cooled, and the combined mass of the aluminum dish and the solid content of the oil phase was measured with an electronic balance. The mass of the solid content of the oil phase was calculated by subtracting the mass of the aluminum dish from the combined mass of the aluminum dish and the solid content of the oil phase, then the solid content concentration of the oil phase was calculated by dividing the mass of the solid content of the oil phase by the mass of the oil phase placed. The proportion of the amount of the solvent to the solid content in the oil phase is calculated by subtracting the mass of the solid content of the oil phase from the mass of the oil phase to obtain a value (the mass of the solvent) and dividing this value by the mass of the solid content of the oil phase.

### <Measurement of Volume Average Particle Diameter of Toner>

The volume average particle diameter of each of the toners used in Examples 1 to 13 and Comparative Examples 1 to 5 was measured by the Coulter counter method.

As a measuring apparatus for measuring the volume average particle diameter of each toner, COULTER MULTISIZER II (manufactured by Coulter Corporation) was used.

Firstly, 0.1 mL to 5 mL of a surfactant (alkylbenzenesulfonate) was added as a dispersant into 100 mL to 150 mL of an electrolytic aqueous solution. Here, the electrolytic aqueous solution was an approximately 1% (by mass) NaCl aqueous solution prepared using primary sodium chloride; specifically, ISOTON-II (manufactured by Coulter Corporation) was used as the electrolytic aqueous solution. Subsequently, 2 mg to 20 mg of a measurement sample was added. The electrolytic aqueous solution in which the sample was suspended was subjected to dispersion treatment for approximately 1 minute to approximately 3 minutes using an ultrasonic dispersing apparatus. Then, by means of the measuring apparatus, with an aperture of 100 μm employed, the volume and the number of toner (toner particles) were measured, and the volume distribution and the number distribution were calculated. The volume average particle diameter and the number average particle diameter of the toner were calculated from the obtained distributions.

As channels, the following 13 channels were used, and particles having diameters greater than or equal to 2.00 μm but less than 40.30 μm were targeted: a channel of 2.00 μm or greater, but less than 2.52 μm; a channel of 2.52 μm or greater, but less than 3.17 μm; a channel of 3.17 μm or greater, but less than 4.00 μm; a channel of 4.00 μm or greater, but less than 5.04 μm; a channel of 5.04 μm or greater, but less than 6.35 μm; a channel of 6.35 μm or greater, but less than 8.00 μm; a channel of 8.00 μm or greater, but less than 10.08 μm; a channel of 10.08 μm or greater, but less than 12.70 μm; a channel of 12.70 μm or greater, but less than 16.00 μm; a channel of 16.00 μm or greater, but less than 20.20 μm; a channel of 20.20 μm or greater, but less than 25.40 μm; a channel of 25.40 μm or greater, but less than 32.00 μm; and a channel of 32.00 μm or greater, but less than 40.30 μm.

### <Measurement of Average Circularity E of Toner>

The average circularity E of each of the toners used in Examples 1 to 13 and Comparative Examples 1 to 5 is defined as follows: Average circularity E=(Circumferential length of circle having area equal to projected area of particle/Circumferential length of projected image of particle)×100% Measurement was carried out using a flow-type particle image analyzer (FPIA-2100, manufactured by SYSMEX CORPORATION), and data was analyzed using analysis software (FPIA-2100 DATA PROCESSING PROGRAM FOR FPIA Version 00-10).

Specifically, 0.1 mL to 0.5 mL of a 10% (by mass) surfactant (NEOGEN SC-A, which is an alkylbenzenesulfonate, manufactured by Dai-ichi Kogyo Seiyaku Co., Ltd.) was poured into a 100 mL glass beaker, 0.1 g to 0.5 g of the toner was added, the ingredients were stirred using a microspatula, then 80 mL of ion-exchange water was added. The obtained dispersion liquid was subjected to dispersion treatment for 3 minutes using an ultrasonic dispersing apparatus (manufactured by HONDA ELECTRONICS). Using FPIA-2100, the shape and distribution of toner particles were measured until the concentration of the dispersion liquid was such that the number of particles was in the range of 5,000 per microliter to 15,000 per microliter.

In this measuring method, it is important (in terms of reproducibility of measurement of the average circularity) to adjust the concentration of the dispersion liquid such that the number of particles is in the range of 5,000 per microliter to 15,000 per microliter. To obtain the foregoing concentration of the dispersion liquid, it is necessary to appropriately adjust conditions of the dispersion liquid, namely the amount of the surfactant added and the amount of the toner added. As in the above-mentioned measurement of the particle diameter of the toner, the required amount of the surfactant varies depending upon the hydrophobicity of the toner; noise is caused by foaming when the amount of the surfactant added is large, and the toner cannot be sufficiently wetted when the amount of the surfactant added is small, thereby leading to insufficient dispersion. Also, the amount of the toner added varies depending upon its particle diameter; the amount of the toner added needs to be small when the toner has a small particle diameter, and the amount of the toner added needs to be large when the toner has a large particle diameter. In the case where the particle diameter of the toner is in the range of 3 μm to 7 μm, addition of 0.1 g to 0.5 g of the toner makes it possible to adjust the concentration of the dispersion liquid such that the number of particles is in the range of 5,000 per microliter to 15,000 per microliter.

### <Evaluation of Fixation Lower Limit Temperature>

The fixation lower limit temperature of each of the toners used in Examples 1 to 13 and Comparative Examples 1 to 5 was measured as follows: a fixing device (mentioned below) was used, adjustment was carried out such that each toner was developed in an amount of 1.0 mg/cm²±0.05 mg/cm² as a solid image on plain paper (TYPE 6200, manufactured by Ricoh Company, Ltd.), and adjustment was carried out such that the temperature of a fixing unit became variable. Note that the fixation lower limit temperature was defined as the temperature of a fixing belt, at which the residual rate of image density was 70% or higher after a pad had been rubbed against a fixed image obtained.

As the fixing device, a fixing device of soft roller type with a fluorine-based surface layer material was used. Specifically, there was a heating roller (40 mm in outer diameter) including an aluminum core, also including, over this aluminum core, an elastic material layer (1.5 mm in thickness) made of silicone rubber and a PFA (tetrafluoroethylene-perfluoroalkyl vinyl ether copolymer) surface layer, and further including a heater inside the aluminum core. Also, there was a pressurizing roller (35 mm in outer diameter) including an aluminum core, and also including, over this aluminum core, an elastic material layer (3 mm in thickness) made of silicone rubber and a PFA surface layer. At the portion where the heating roller and the pressurizing roller press against each other, there was a nip (7 mm in nip width) formed. The experiment was carried out without using fixing oil. Note that there was no practical problem arising when the fixation lower limit temperature was 140° C. or higher, but lower than 145° C.

### [Evaluation Criteria]

A: The fixation lower limit temperature was lower than 135° C.

B: The fixation lower limit temperature was 135° C. or higher, but lower than 140° C.

C: The fixation lower limit temperature was 140° C. or higher, but lower than 145° C.

D: The fixation lower limit temperature was 145° C. or higher.

### <Evaluation of Cleanability Based Upon Smearing of Charging Roller>

The cleanability of each of the toners used in Examples 1 to 13 and Comparative Examples 1 to 5 was evaluated based upon the extent to which a charging roller was smeared when a predetermined print pattern with a B/W ratio of 6% had been continuously printed onto 1,000 sheets in an N/N (normal-temperature and normal-humidity) environment, i.e., at 23° C. and 45%, using a color laser printer (IPSIO SP C220, manufactured by Ricoh Company, Ltd.) set in monochrome mode.

To ascertain the extent to which the charging roller was smeared, toner remaining on the charging roller when the printing onto the 1,000 sheets had finished was detached using tape, and the L* value of the toner was measured using a spectrodensitometer (XRITE 939).

### [Evaluation Criteria]

A: The L* value was 90 or greater.

B: The L* value was 85 or greater, but less than 90.

C: The L* value was less than 85.

### <Evaluation of Transferrability Based Upon Transfer Efficiency>

The transferrability of each of the toners used in Examples 1 to 13 and Comparative Examples 1 to 5 was evaluated based upon the transfer efficiency when a predetermined print pattern with a B/W ratio of 6% had been continuously printed onto 1,000 sheets in an N/N (normal-temperature and normal-humidity) environment, i.e., 23° C. and 45%, using a color laser printer (IPSIO SP C220, manufactured by Ricoh Company, Ltd.) set in monochrome mode.

The transfer efficiency was calculated from the amount A of the toner used for development at the time when the printing onto the 1,000 sheets had finished, and the amount B of the toner which remained instead of being transferred and which was subsequently recovered.

Transfer efficiency=(A−B)/A×100

### [Evaluation Criteria]

A: The transfer efficiency was 90% or greater.

B: The transfer efficiency was 85% or greater, but less than 90%.

C: The transfer efficiency was less than 85%.

TABLE 1-1

| | | Vinyl resin fine particle dispersion liquid | | | | | | | | |
|---|---|---|---|---|---|---|---|---|---|---|
| | | | | | | Chain | | | | |
| | | | | | | transfer | | | | |
| | | | Monomer composition | | | agent | | | | |
| | | Vinyl | St | BA | MAA | NOM | Physical properties | | | |
| | | resin fine | (% by | (% by | (% by | (% by | | | Tg | Mv |
| | | particles | mass) | mass) | mass) | mass) | Mn | Mw | (° C.) | (nm) |
| Ex. 1 | Toner | Resin Fine | 100 | — | — | 4.1 | 8,200 | 15,600 | 83 | 121 |
| | 1 | Particles 1 | | | | | | | | |
| Ex. 2 | Toner | Resin Fine | 100 | — | — | 8.4 | 4,800 | 8,500 | 62 | 133 |
| | 2 | Particles 2 | | | | | | | | |
| Ex. 3 | Toner | Resin Fine | 95.5 | 2 | 2.5 | 4.8 | 11,000 | 15,100 | 81 | 120 |
| | 3 | Particles 3 | | | | | | | | |
| Ex. 4 | Toner | Resin Fine | 85 | 10 | 5 | 4.7 | 11,500 | 15,000 | 79 | 80 |
| | 4 | Particles 4 | | | | | | | | |
| Ex. 5 | Toner | Resin Fine | 100 | — | — | 4.1 | 8,200 | 15,600 | 83 | 121 |
| | 5 | Particles 1 | | | | | | | | |
| Ex. 6 | Toner | Resin Fine | 95.5 | 2 | 2.5 | 4.8 | 11,000 | 15,100 | 81 | 120 |
| | 6 | Particles 3 | | | | | | | | |
| Ex. 7 | Toner | Resin Fine | 85 | 10 | 5 | 4.7 | 11,500 | 15,000 | 79 | 80 |
| | 7 | Particles 4 | | | | | | | | |
| Ex. 8 | Toner | Resin Fine | 85 | 15 | — | 4.1 | 8,300 | 15,900 | 55 | 100 |
| | 8 | Particles 9 | | | | | | | | |
| Ex. 9 | Toner | Resin Fine | 100 | — | — | 6 | 5,900 | 10,600 | 68 | 90 |
| | 9 | Particles 10 | | | | | | | | |
| Ex. 10 | Toner | Resin Fine | 80 | 20 | — | 3.7 | 8,500 | 15,800 | 58 | 92 |
| | 10 | Particles 11 | | | | | | | | |
| Ex. 11 | Toner | Resin Fine | 90 | 10 | — | 4.8 | 7,600 | 13,500 | 74 | 100 |
| | 11 | Particles 12 | | | | | | | | |
| Ex. 12 | Toner | Resin Fine | 97 | — | 3 | 3.5 | 8,800 | 15,900 | 98 | 111 |
| | 12 | Particles 13 | | | | | | | | |
| Ex. 13 | Toner | Resin Fine | 97 | — | 3 | 4 | 8,700 | 15,700 | 103 | 98 |
| | 13 | Particles 14 | | | | | | | | |
| Comp. | Toner | Resin Fine | 100 | — | — | 3.7 | 12,200 | 18,900 | 99 | 110 |
| Ex. 1 | 14 | Particles 5 | | | | | | | | |
| Comp. | Toner | Resin Fine | 100 | — | — | 9.8 | 4,000 | 7,500 | 55 | 140 |
| Ex. 2 | 15 | Particles 6 | | | | | | | | |
| Comp. | Toner | Resin Fine | 100 | — | — | 3.5 | 13,800 | 20,000 | 105 | 108 |
| Ex. 3 | 16 | Particles 7 | | | | | | | | |
| Comp. | Toner | Resin Fine | 100 | — | — | 10 | 3,500 | 7,000 | 52 | 145 |
| Ex. 4 | 17 | Particles 8 | | | | | | | | |
| Comp. | Toner | Resin Fine | 75 | 25 | — | 6 | 5,900 | 10,600 | 51 | 100 |
| Ex. 5 | 18 | Particles 15 | | | | | | | | |

NOM denotes n-octanethiol.

TABLE 1-2

| | | Binder resin | | | | | |
|---|---|---|---|---|---|---|---|
| | | High-molecular- | | Low-molecular- | | Release agent | |
| | | weight resin | | weight resin | | | Amount |
| | | Type of resin | Ratio | Type of resin | Ratio | Type | (Parts by mass) |
| Ex. 1 | Toner | Isocyanate- | 10 | Polyester | 90 | Paraffin | 8 |
| | 1 | modified | | 1 | | wax | |
| | | Polyester 1 | | | | | |
| Ex. 2 | Toner | Isocyanate- | 10 | Polyester | 90 | Paraffin | 8 |
| | 2 | modified | | 1 | | wax | |
| | | Polyester 1 | | | | | |
| Ex. 3 | Toner | Isocyanate- | 10 | Polyester | 90 | Paraffin | 8 |
| | 3 | modified | | 1 | | wax | |
| | | Polyester 1 | | | | | |
| Ex. 4 | Toner | Isocyanate- | 10 | Polyester | 90 | Paraffin | 8 |
| | 4 | modified | | 1 | | wax | |
| | | Polyester 1 | | | | | |
| Ex. 5 | Toner | Polyester 2 | 40 | Polyester | 60 | Paraffin | 8 |
| | 5 | | | 3 | | wax | |
| Ex. 6 | Toner | Polyester 2 | 40 | Polyester | 60 | Paraffin | 8 |
| | 6 | | | 3 | | wax | |
| Ex. 7 | Toner | Polyester 2 | 40 | Polyester | 60 | Paraffin | 8 |
| | 7 | | | 3 | | wax | |
| Ex. 8 | Toner | Isocyanate- | 10 | Polyester | 90 | Paraffin | 8 |
| | 8 | modified | | 1 | | wax | |
| | | Polyester 1 | | | | | |
| Ex. 9 | Toner | Isocyanate- | 10 | Polyester | 90 | Paraffin | 8 |
| | 9 | modified | | 1 | | wax | |
| | | Polyester 1 | | | | | |
| Ex. 10 | Toner | Isocyanate- | 10 | Polyester | 90 | Paraffin | 8 |
| | 10 | modified | | 1 | | wax | |
| | | Polyester 1 | | | | | |
| Ex. 11 | Toner | Isocyanate- | 10 | Polyester | 90 | Paraffin | 8 |
| | 11 | modified | | 1 | | wax | |
| | | Polyester 1 | | | | | |
| Ex. 12 | Toner | Isocyanate- | 10 | Polyester | 90 | Paraffin | 8 |
| | 12 | modified | | 1 | | wax | |
| | | Polyester 1 | | | | | |
| Ex. 13 | Toner | Isocyanate- | 10 | Polyester | 90 | Paraffin | 8 |
| | 13 | modified | | 1 | | wax | |
| | | Polyester 1 | | | | | |
| Comp. | Toner | Isocyanate- | 10 | Polyester | 90 | Paraffin | 8 |
| Ex. 1 | 14 | modified | | 1 | | wax | |
| | | Polyester 1 | | | | | |
| Comp. | Toner | Isocyanate- | 10 | Polyester | 90 | Paraffin | 8 |
| Ex. 2 | 15 | modified | | 1 | | wax | |
| | | Polyester 1 | | | | | |
| Comp. | Toner | Isocyanate- | 10 | Polyester | 90 | Paraffin | 8 |
| Ex. 3 | 16 | modified | | 1 | | wax | |
| | | Polyester 1 | | | | | |
| Comp. | Toner | Isocyanate- | 10 | Polyester | 90 | Paraffin | 8 |
| Ex. 4 | 17 | modified | | 1 | | wax | |
| | | Polyester 1 | | | | | |
| Comp. | Toner | Isocyanate- | 10 | Polyester | 90 | Paraffin | 8 |
| Ex. 5 | 18 | modified | | 1 | | wax | |
| | | Polyester 1 | | | | | |

TABLE 2

| | | | | | Fixation lower | | | | | |
|---|---|---|---|---|---|---|---|---|---|---|
| | | | | | limit temperature | | | | Transferrability | |
| | | | | | | Tempera- | Cleanability | | | Transfer |
| | | Dv | | | Evalua- | ture | Evalua- | | Evalua- | efficiency |
| | | (μm) | Dv/Dn | Circularity | tion | (° C.) | tion | L* | tion | (%) |
| Ex. 1 | Toner | 6.1 | 1.14 | 0.97 | C | 142 | A | 92 | A | 98 |
| | 1 | | | | | | | | | |
| Ex. 2 | Toner | 6.5 | 1.16 | 0.98 | A | 133 | B | 89 | B | 89 |
| | 2 | | | | | | | | | |
| Ex. 3 | Toner | 6.4 | 1.13 | 0.96 | B | 139 | A | 91 | A | 94 |
| | 3 | | | | | | | | | |
| Ex. 4 | Toner | 6.8 | 1.19 | 0.98 | C | 140 | B | 87 | B | 88 |
| | 4 | | | | | | | | | |
| Ex. 5 | Toner | 6.5 | 1.18 | 0.97 | C | 144 | A | 91 | A | 95 |
| | 5 | | | | | | | | | |
| Ex. 6 | Toner | 6.7 | 1.13 | 0.98 | C | 140 | B | 86 | B | 87 |
| | 6 | | | | | | | | | |
| Ex. 7 | Toner | 6.7 | 1.13 | 0.97 | B | 138 | B | 86 | B | 88 |
| | 7 | | | | | | | | | |
| Ex. 8 | Toner | 6.9 | 1.15 | 0.97 | C | 144 | B | 88 | B | 86 |
| | 8 | | | | | | | | | |
| Ex. 9 | Toner | 6.1 | 1.12 | 0.97 | A | 134 | A | 90 | A | 90 |
| | 9 | | | | | | | | | |
| Ex. 10 | Toner | 6 | 1.12 | 0.97 | C | 144 | B | 88 | B | 87 |
| | 10 | | | | | | | | | |
| Ex. 11 | Toner | 6.2 | 1.12 | 0.97 | C | 140 | B | 89 | B | 88 |
| | 11 | | | | | | | | | |
| Ex. 12 | Toner | 6 | 1.13 | 0.97 | C | 140 | A | 93 | A | 97 |
| | 12 | | | | | | | | | |
| Ex. 13 | Toner | 6.3 | 1.14 | 0.97 | C | 140 | A | 91 | A | 95 |
| | 13 | | | | | | | | | |
| Comp. | Toner | 6.4 | 1.14 | 0.97 | D | 150 | A | 92 | A | 94 |
| Ex. 1 | 14 | | | | | | | | | |
| Comp. | Toner | 6.1 | 1.14 | 0.98 | A | 130 | C | 82 | C | 82 |
| Ex. 2 | 15 | | | | | | | | | |
| Comp. | Toner | 6.4 | 1.14 | 0.95 | D | 149 | A | 91 | A | 94 |
| Ex. 3 | 16 | | | | | | | | | |
| Comp. | Toner | 6.1 | 1.14 | 0.96 | A | 131 | C | 82 | C | 81 |
| Ex. 4 | 17 | | | | | | | | | |
| Comp. | Toner | 6 | 1.15 | 0.97 | A | 131 | C | 80 | C | 83 |
| Ex. 5 | 18 | | | | | | | | | |

Dn denotes number average particle diameter.
Dv denotes volume average particle diameter.

The present invention's toner for an electrostatic image developer can be fixed at a low temperature, has superior stability in terms of durability without causing smearing of developing members with a carrier and has favorable transferrability and cleanability, and the toner can be suitably used as a latent electrostatic image developing toner for an electrophotographic image forming apparatus.

What is claimed is:

1. A toner for an electrostatic image developer, comprising:
a core particle obtained by dispersing, in an aqueous medium, an oil phase prepared by dissolving or dispersing at least a binder resin, a colorant and a release agent in an organic solvent; and
a shell layer formed of vinyl resin fine particles present on a surface of the core particle,
wherein the shell layer has protruding portions formed of the vinyl resin fine particles, and
wherein the vinyl resin fine particles contain 80% by mass or more of an aromatic compound which has a vinyl-polymerizable functional group, and a vinyl resin which forms the vinyl resin fine particles has a weight average molecular weight of 8,000 to 16,000.

2. The toner according to claim 1, wherein the vinyl resin fine particles contain 90% by mass or more of the aromatic compound which has the vinyl-polymerizable functional group.

3. The toner according to claim 1, wherein the vinyl resin is composed of a polymerization product of the aromatic compound which has the vinyl-polymerizable functional group.

4. The toner according to claim 1, wherein the aromatic compound which has the vinyl-polymerizable functional group is styrene.

5. The toner according to claim 1, wherein the vinyl resin fine particles have a glass transition temperature of 55° C. to 100° C.

6. The toner according to claim 1, wherein the binder resin has an acid value of 2 mgKOH/g to 24 mgKOH/g.

7. The toner according to claim 1, wherein the binder resin is a polyester resin.

8. The toner according to claim 1, further comprising an isocyanate group-terminated modified resin dissolved in the oil phase.

9. The toner according to claim 8, wherein the modified resin has a polyester backbone in a molecular structure thereof.

10. The toner according to claim 8, further comprising, in the oil phase, an amine compound containing a divalent or higher amino group which is capable of reacting with the isocyanate group of the modified resin.

11. The toner according to claim 1, having an average circularity of 0.96 to 1.

12. A process cartridge detachably mountable to an image forming apparatus, comprising:
a latent image bearing member; and
a developing device configured to develop a latent image on the latent image bearing member, using a developer which includes a toner for an electrostatic image developer,
the latent image bearing member and the developing device forming a single unit,
wherein the toner comprises; a core particle obtained by dispersing, in an aqueous medium, an oil phase prepared by dissolving or dispersing at least a binder resin, a colorant and a release agent in an organic solvent; and a shell layer formed of vinyl resin fine particles present on a surface of the core particle,
wherein the shell layer has protruding portions formed of the vinyl resin fine particles, and
wherein the vinyl resin fine particles contain 80% by mass or more of an aromatic compound which has a vinyl-polymerizable functional group, and a vinyl resin which forms the vinyl resin fine particles has a weight average molecular weight of 8,000 to 16,000.

13. An image forming apparatus comprising:
a latent image bearing member configured to bear a latent image;
a charging unit configured to charge a surface of the latent image bearing member uniformly;
an exposing unit configured to expose the charged surface of the latent image bearing member based upon image data so as to write a latent electrostatic image on the surface of the latent image bearing member;
a developing unit configured to supply a toner for an electrostatic image developer to the latent electrostatic image on the surface of the latent image bearing member so as to make the latent electrostatic image into a visible image;
a transfer unit configured to transfer the visible image on the surface of the latent image bearing member onto a transfer target; and
a fixing unit configured to fix the visible image on the transfer target,
wherein the toner comprises: a core particle obtained by dispersing, in an aqueous medium, an oil phase prepared by dissolving or dispersing at least a binder resin, a colorant and a release agent in an organic solvent; and a shell layer formed of vinyl resin fine particles present on a surface of the core particle,
wherein the shell layer has protruding portions formed of the vinyl resin fine particles, and
wherein the vinyl resin fine particles contain 80% by mass or more of an aromatic compound which has a vinyl-polymerizable functional group, and a vinyl resin which forms the vinyl resin fine particles has a weight average molecular weight of 8,000 to 16,000.
